(19) United States
(12) Patent Application Publication
(10) Pub. No.: US 2024/0168860 A1
(43) Pub. Date: May 23, 2024

(54) APPARATUS AND METHOD FOR COMPUTER-IMPLEMENTED MODELING OF MULTIEVENT PROCESSES

(71) Applicant: Travis James Arlitt, Houston, TX (US)

(72) Inventor: Travis James Arlitt, Houston, TX (US)

(21) Appl. No.: 18/516,421

(22) Filed: Nov. 21, 2023

Related U.S. Application Data
(60) Provisional application No. 63/427,047, filed on Nov. 21, 2022.

(51) Int. Cl. G06F 11/34

(52) U.S. Cl. CPC G06F 11/3447

(57) ABSTRACT

A method for modeling a multi-event process, comprising loading a digitized representation of a plurality of events, wherein the plurality of events comprises a first sub-set of events linked to a sub-set of historical events, generating a first visual representation of the digitized representation of the plurality of events using a display device by generating a plurality of visual indicators, each visual indicator is configured to represent at least a percentage of an event progress of the first sub-set of events, modifying at least one event attribute associated with the plurality of events, computing an event progress profile corresponding to the first sub-set of events as a function of the modified at least one event attribute, and generating a second visual representation of the digitized representation of the plurality of events using the display device.

### CROSS-REFERENCE TO RELATED APPLICATIONS

This application claims the benefit of priority of U.S. Provisional Patent Application Ser. No. 63/427,047, filed on Nov. 21, 2022, and titled “COMPUTER-IMPLEMENTED MODELING OF MULTI-EVENT PROCESS,” which is incorporated by reference herein in its entirety.

### FIELD OF THE INVENTION

The present invention generally relates to the field of computer-implemented systems, devices, and/or computing platforms to bring about the modeling of a multi-event process, such as in relation to a multi-event or multi-phase effort. In particular, the present invention is directed to an apparatus and method for computer-implemented modeling of multi-event process.

### BACKGROUND

Due to the complexity and interdependency inherent in multi-event processes, modeling such processes stands as a critical and intricate element in the domain of process management. Each event within these processes may often depend on the completion or progression of multiple other events, creating a network of dependencies that can be challenging to visualize, track, and predict. Traditional tools fail to provide an intuitive and interactive means for users to manipulate multi-event process progress and resources.

### SUMMARY OF THE DISCLOSURE

In an aspect, a method for modeling a multi-event process is described. The method includes loading, by at least one processor, a digitized representation of a plurality of events into a memory communicatively connected to the at least one processor, wherein the plurality of events comprises a first sub-set of events linked to a sub-set of historical events. The method also includes generating, by the at least one processor, a first visual representation of the digitized representation of the plurality of events using a display device communicatively connected to the at least one processor, wherein generating the first visual representation of the digitized representation of the plurality of events comprises generating a plurality of visual indicators, wherein each visual indicator of the plurality of visual indicators is configured to represent at least a percentage of an event progress of the first sub-set of events. The method further includes modifying, by the at least one processor, at least one event attribute associated with the plurality of events, computing, by the at least one processor, an event progress profile corresponding to the first sub-set of events as a function of the modified at least one event attribute, and generating, by the at least one processor, a second visual representation of the digitized representation of the plurality of events using the display device.

In another aspect, an apparatus for modeling a multi-event process is described. The apparatus includes at least one processor and a memory communicatively connected to the at least one processor, wherein the memory contains instructions configuring the at least one processor load a digitized representation of a plurality of events into the memory, wherein the plurality of events includes a first sub-set of events linked to a sub-set of historical events. The at least one processor is also configured to generate a first visual representation of the digitized representation of the plurality of events using a display device communicatively connected to the at least one processor, wherein generating the first visual representation of the digitized representation of the plurality of events includes generating a plurality of visual indicators, wherein each visual indicator of the plurality of visual indicators is configured to represent at least a percentage of an event progress of the first sub-set of events. The at least a processor is further configured to modify at least one event attribute associated with the plurality of events, compute an event progress profile corresponding to the first sub-set of events as a function of the modified at least one event attribute, and generate a second visual representation of the digitized representation of the plurality of events using the display device.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1A is an exemplary embodiment of a graph showing job processes in a schedule of a multi-event process to be performed at various points in time;

FIG. 1B is an exemplary embodiment of a graph showing a progress profile of process events over a period of weeks;

FIG. 2 is an exemplary embodiment of a graph showing a progress profile of process events and a resultant bow wave in response to a shortcoming in weekly progress, according to an embodiment;

FIG. 3 is an exemplary embodiment of a graph showing respreading of process events in response to delayed completion of a predecessor event;

FIG. 4 is an exemplary embodiment of a graph showing respread process events, indicating increasing and decreasing rates of progress, in response to delayed completion of a predecessor event;

FIG. 5, is a flowchart for an exemplary method for computer-implemented modeling of a multi-event process;

FIG. 6 is a schematic block diagram illustrating an exemplary computing system environment;

FIG. 7 is a schematic block diagram illustrating an exemplary computing environment to facilitate computer-implemented modeling of a multi-event process;

FIG. 8 is a first exemplary embodiment of a graph showing respreading of process events in response to linking of a computer-implemented model for a multi-event process with a computer-implemented calendaring tool;

FIG. 9 is a second exemplary embodiment of a graph showing respreading of process events in response to linking of a computer-implemented model for a multi-event process with a computer-implemented calendaring tool;

FIG. 10 is a third exemplary embodiment of a graph showing respreading of process events in response to linking of a computer-implemented model for a multi-event process with a computer-implemented calendaring tool;

FIG. 11 is a block diagram illustrating an exemplary embodiment of a machine learning module; and

FIG. 12 is a block diagram of a computing system that can be used to implement any one or more of the methodologies disclosed herein and any one or more portions thereof.

### DETAILED DESCRIPTION

References throughout this specification to one implementation, an implementation, one embodiment, an embodiment and/or the like means that a particular feature, structure, and/or characteristic described in connection with a particular implementation and/or embodiment is included in at least one implementation and/or embodiment of claimed subject matter. Thus, appearances of such phrases, for example, in various places throughout this specification are not necessarily intended to refer to the same embodiment or to any one particular embodiment described. Furthermore, it is to be understood that particular features, structures, representations, indications and/or characteristics described are capable of being combined in various ways in one or more embodiments and, therefore, are within intended claim scope, for example. In general, of course, these and other issues vary with context. Therefore, particular context of description and/or usage provides guidance regarding inferences to be drawn.

In a multi-event process, which may involve various time-phased processes, subprocesses, and/or events, a contractor, for example, may submit a proposal, which may include a time-phased process schedule to indicate the various processes, subprocesses, and/or events to be executed during a period of performance. Thus, a proposed schedule may indicate certain activities, many of which are scheduled to be performed prior to initiation of certain other activities. For example, a contractor proposing to construct a freeway bypass, bridge, or other structure, may begin with surveying, excavation, and grading prior to preparation of rebar substructures and form setting, which may be followed by pouring concrete, masonry, and other processes. In many instances, detailed scheduling of construction activities may be subject to oversight by a contracting officer, who may be tasked with ensuring that a contractor performs all needed activities, preferably in accordance with the proposed schedule and a proposed budget.

However, in some instances, a contractor, for example, may experience difficulties in adhering to an agreed-upon schedule of a multi-event construction process. In such instances, the contractor, for example, may wish to revise and/or update the agreed-upon schedule so as to reschedule certain activities. Such replanning of construction activities may be based, at least in part, on delays due to weather, availability of materials, equipment, availability of appropriate tradespeople, unplanned and/or unscheduled work stoppages, holidays, workplace mishaps, and so forth.

Consequently, a contractor may prepare a revised schedule, which, hopefully, provides the contracting officer or other overseer, for example, with a revised time-phased process schedule that indicates the contractor's plan for minimizing delays, cost overruns, and so forth. Such re-scheduling of the various time-phased processes may influence the contracting officer's scheduling of progress payments made to the contractor as well as allocating certain resources that the contractor may need to complete the multi-event process. In many instances, however, such contractor-provided schedule updates may be suspect, obscured, or not readily available so as to provide little insight into the contractor's actual plan of the multi-event process. Accordingly, improvements in multi-event scheduling continue to be an active area of investigation.

As described herein, a “multi-event process” is a various time-phase process having one or more subprocesses, events, and the like. In some cases, a contractor, for example, may submit a proposal, which may include a time-phased schedule of process events. A time-phased process schedule, which may indicate process events to occur on a daily basis, weekly basis, monthly basis, etc., may be utilized to indicate the various processes, subprocesses, and/or events to be executed during a contractor's period of performance. Thus, a proposed schedule for completing a multi-event process may indicate certain time-phased activities, many of which may be scheduled to be performed prior to initiation of certain other activities. In an example, a contractor proposing to construct a freeway bypass, bridge, chemical processing facility, refinery, or any other structure or system of structures, may begin with surveying, excavation, and/or grading prior to preparation of rebar substructures and form setting, piping, etc., which may be followed by pouring concrete, masonry, application of asphalt, and other processes. In many instances, detailed scheduling of construction activities may be subject to oversight by a contracting officer, who may be tasked with ensuring that the one or more contractors perform all needed activities, preferably in accordance with the proposed schedule and within a proposed budget.

However, in some instances, a contractor, may experience difficulties in adhering to an agreed-upon schedule of a multi-event construction process. In such instances, the contractor, for example, may wish to revise and/or update the agreed-upon schedule so as to reschedule certain activities. Rescheduling and/or replanning of construction activities may place a premium on completing the multi-event process at a particular, and previously agreed-upon, completion date. In some instances, replanning and/or rescheduling of construction activities may be in response to construction delays due to unforeseen weather interruptions, a contractor performance factor, availability of materials, equipment constraints, availability of skilled tradespeople, unplanned and/or unscheduled work stoppages, holidays, workplace mishaps, and so forth.

In such embodiment, while executing a multi-event-process, a contractor may prepare a revised schedule or other type of plan for the completion of the multi-event process, which, hopefully, provides the contracting officer, customer, or other type of overseer, with a revised time-phased process schedule that specifies, in appropriate detail, the contractor's plan or approach for minimizing delays, cost overruns, and so forth. Such re-scheduling of the various time-phased processes may influence the contracting officer's scheduling of progress payment intervals to be made to the contractor as well as allocating certain resources that the contractor may need to complete the multi-event process. In many instances, however, such contractor-provided schedule updates may be suspect, obscured, or not available in a timely manner. Accordingly, in some instances, contractor-provided schedule updates may provide little insight into the contractor's actual plan for completion of the multi-event process.

In a non-limiting example, a contractor may utilize a typical scheduling tool that does not provide sufficient granularity in identifying events of various processes and/or subprocesses of a multi-event process. Thus, in such instances, a contractor may provide a contracting officer, customer, or other overseer, with a revised schedule that includes only a handful (e.g., 7, 10, or 15, or more or less) of replanned process events, which may not embody sufficient detail to appropriately advise the contracting officer, customer, or other overseer. Further, typical scheduling tools may operate in an unwieldy manner, which may not permit the contractor to provide timely updates to the contracting officer or other overseer. Such typical scheduling tools may thus permit a contractor to hide or obscure replanned/rescheduled details of a multi-event process. Such hiding or obscuration of replanned details of a multi-event process may place the contracting officer, customer, or other type of overseer into a state of relative ignorance as to which processes, subprocesses, and/or events of the multi-event process are being delayed and/or impacted.

Accordingly, in some embodiments, apparatus as described herein i.e., a computer-implemented modeling tool for a multi-event process may overcome a number of shortcomings present in typical scheduling tools. In a non-limiting example, apparatus described herein may be configured to provide one or more visual representations, such as a bar graph, Gantt chart, or other indication, that quickly and interactively displays respread events of a process in response to modifying an event attribute of one or more predecessor events. As described herein, an “event attribute” refers to a parameter relating to at least one event. In a non-limiting example, event attribute of an originally scheduled predecessor event may refer a date (e.g., timestamp) of completion of the predecessor event. Accordingly, as used in this disclosure, a “modified event attribute” is a modification of a parameter of a predecessor event. In some cases, a modified event attribute of a predecessor event may refer to a delay in completing one or more predecessor events, a shortening of a duration of one or more predecessor events, or modifying any other parameter of the predecessor event. Predecessor events may be used interchangeably with “historical events” as described herein.

In a non-limiting example, in response to modifying an event attribute of the predecessor event, such as realizing a delay in completion of one or more predecessor events of a series of time-phased events, apparatus as described herein may include a facility to permit a user such as a contractor to indicate that remaining events of the series of events are to be completed at a faster rate (e.g., a greater percentage of completion per day, per week, per month, etc.) so as to maintain an agreed-upon completion date. Thus, in one possible example, in response to a two-week weather or holiday delay, which affects the rate at which concrete can be poured, apparatus as described herein may be configured to indicate that the contractor is required to pour concrete at a faster rate during the remaining weeks allocated for concrete pouring events.

In some embodiments, apparatus as described herein may be utilized to quickly and interactively display one or more visual representations of respread events of a first process in response to, for example, a delay in completing one or more predecessor events of a second process. For example, in a possible embodiment, in response to a process comprising laying of underground pipes in a multi-event process of constructing an oil refinery, a two-week delay in fabricating and laying pipes into open trenches, such as due to holiday-related personnel shortages or any other event that affects a contractor performance factor, may delay a first process pipe weld inspection and/or covering of completed pipe trenches with earth. In such an instance, in view of the two-week delay in constructing and laying pipes, a contractor may be tasked with increasing a rate of pipe weld inspection and covering of completed pipe trenches during the remaining weeks allocated for covering piped-out trenches with earth or other materials.

In some embodiments, one or more predecessor events may be linked or coupled to a time-phased schedule of process events. As used in this disclosure, a “link” between a predecessor event of the time-phased schedule of process events is a relationship between the predecessor and subsequent process events, in which the predecessor event is to be completed prior to or coincident with initiation of the time-phased schedule of process events. In a non-limiting example, a predecessor inspection event that refers to inspection of pipe weld quality may be essential prior to covering a piped-out trench with earth. In another non-limiting example, a predecessor event may be “linked” to a plurality of time-phased process events. In a further non-limiting example, a predecessor event relating to assembly of a concrete-mixing facility, or completed up to a certain percentage, may be scheduled to occur prior to two or more time-phased process events, such as surveying, obtaining one or more concrete pumps, form setting, and so forth.

In addition, in some embodiments, apparatus described herein utilize a computing platform that facilitates interactive real-time or near-real-time viewing of various contingency scenarios. Thus, based, at least in part, on computing power of a computing platform, such as via the use of multiple processors, enhanced memory caching, and/or other computer hardware features, a contracting officer or other overseer may be capable of interactively generating visual representations of revised scheduling details with merely a few computer keystrokes. Thus, it may be appreciated that computer-implemented modeling of a multi-event process may provide the ability to interactively generate numerous informal or “what if” speculations based on virtually any number of scenarios, for example, in completing scheduled events of a multi-event process.

It may be appreciated that, at least in particular embodiments, an ability to quickly and/or interactively replan and/or reschedule events of a multi-event process, may be instrumental in assisting a contractor, for example, in avoiding certain scenarios in which a delay of one or more process events gives rise to an undesirable “bow wave” of activity at a future date of a scheduled process. In this context, the term “bow wave” refers to an undesirable accumulation of effects of an estimation process in which one or more delays in a sequential series of events leads to a burst of activity at a future date. In one possible example, if a series of process events involves pouring concrete at a completion rate of 5% per week for 20 weeks, a shortcoming in weekly concrete pouring events, such as pouring concrete at a rate of 4% per week for 19 weeks, leads to a need to pour a remaining 24% of concrete at week 20. Thus, it may be appreciated that precluding such “bow wave” events from occurring may serve the interests of contractors as well as contracting officers and/or customers alike.

In some embodiments, at least one processor may facilitate the interactive generation of one or more visual representations showing increasing rates of progress (e.g., “ramp up”) over time as well as decreasing rates (e.g., “ramp down”) of progress. Thus, in one possible example, as rainy weather decreases during spring and summer months, process events may be interactively scheduled and visually represented to show increases, such as from a progress profile of 3% per week in March to a progress profile of 6% per week in June, followed by, for example, a progress profile that returns to 3% during rain-prone November.

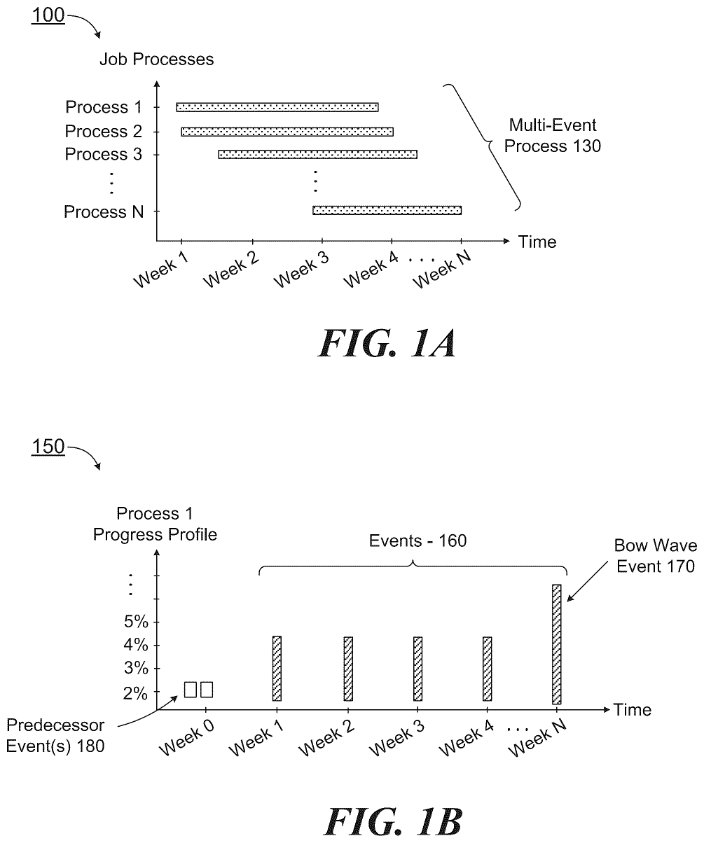

Now referring to FIG. 1A, an exemplary embodiment of a graph 100 showing job processes in a schedule of a multi-event process to be performed at various points in time is illustrated. As depicted in FIG. 1A, the vertical axis depicts job processes, and the horizontal axis depicts time in weeks. Thus, as shown, process 1 initiates at week 1 and completes at week 4. Process 2 is shown as initiating at week 1 slightly after process 1 and completing at week 4, slightly after completion of process 1. Process 3 is shown as initiating at a middle point of week 1 and completing at a middle point of week 4. It should be understood that processes of FIG. 1A may include any number of processes similar to processes 1, 2, and 3, such as 10 processes, 20 processes, hundreds of processes, or even thousands of job processes. Accordingly, process N may represent any number of processes of a multi-event process, virtually without limitation.

With continued reference to FIG. 1A, processes of multi-event process 130 are intended to reflect discrete processes of any type of multi-event process. Thus, process 1 may refer to, for example, excavation, such as excavation in preparation for constructing a road or highway. Process 2, for example, may refer to hauling excavated earth from a construction site, while process 3, for example, may refer to surveying of excavated areas in preparation for depositing a capping layer, over which asphalt and other materials may be deposited. Processes 1, 2, 3, . . . , N are intended to comprise “discrete events,” which, for the purpose of this disclosure, refer to one or more discrete occurrences, which may be performed over a period of days, weeks, months, years, or any other discrete period of time. Thus, in a possible example, process 1 may involve excavating, which comprises 4 weekly events of removal of 25% of a total area (or volume) to be excavated.

With continued reference to FIG. 1A, apparatus described herein may further enhance the fluidity of such scheduling process. In some embodiments, multi-event process model may be configured to dynamic adjust the schedule based on one or more event attributes such as, without limitation, a start time and a finish time of any given process within the multi-event process. In some embodiments, start time and a finish time may include a start date and finish date, respectively. For instance, and without limitation, if the finish date of a Process 1 (e.g., excavation) is extended by one week, multi-event process model may automatically adjust the subsequent process, such as a Process 2 (e.g., hauling excavated earth) and a Process 3 (surveying), to align with such change. Thus, in a non-limiting example, such adjustment may be akin to an accordion effect, wherein the extension or compression of one process's duration proportionally affects the durations of subsequent processes.

Continuing reference to FIG. 1A, in some cases, apparatus described herein may allow a user to input a change in one or more event attributes e.g., either a start time or a finish time for any process within the multi-event schedule. Upon receiving user input, multi-event process model may recalculate durations for remaining processes. In one or more embodiments, recalculation may be not merely a linear adjustment; rather, multi-event process may be configured to intelligently configured to consider a plurality of interdependencies of event attributes (i.e., characteristics) of each process. Thus, in a possible example, if Process 1's duration is extended, multi-event process model may adjust the start and finish date of Process 2 and Process 3 accordingly to maintain the integrity and feasibility of the multi-event process.

Still referring to FIG. 1A, additionally, event progress profiles for each process may be updated, in real-time or in near-real-time. In some cases, these updated profiles may be used to compute new production figures or contractor counts required to achieve the revised start and/or finish dates. In a context of a complex projects where multiple processes are interdependent, such dynamic adjustment—a change in one process can have cascading effects on others, may be particularly beneficial to multi-event process model to instantly reflect one or more changes in event attributes and/or event progress profiles and their corresponding visual representations (as per FIG. 1A and subsequent FIGS. 1B-4 and 8-10 as described below) for efficient project management, allowing project teams to promptly access and adapt to schedule changes.

With continued reference to FIG. 1A, in a non-limiting example, visual representation of the multi-event process may include a Gantt chart. When a user modifies the start or finish date of multi-event process 130, such as extending Process N's duration, multi-event process model may intelligently adjust the duration of one or more process over a future duration. Accordingly, in some instances, such adjustment may be graphically depicted as extending or shrinking the corresponding progress bar on the chart to maintain the project timeline while accommodating the new date. As shown in FIG. 1A, the depicted Gantt chart is capable of dynamically representing the accordion effect. User may see the immediate impact of changes on the schedule. In some cases, multi-event process model may be configured to recalculate durations of Processes 1-3 based on modified finish date of Process N, such as, increase (postpone) or decrease (advance) the finish dates of Processes 1-3 and update the Gantt chart in real-time or near-real-time. As such, the Gantt chart may become an interactive tool, not just for planning but also for managing ongoing changes in the project lifecycle. In a particular embodiment, the Gantt chart's fluidity may allow user to input a single event attribute modification (e.g., date change) and have the entire schedule automatically update accordingly.

Now referring to FIG. 1B, an exemplary embodiment of a graph 150 showing a progress profile of process events over a period of weeks is illustrated. As depicted in FIG. 1B, the vertical axis depicts a progress profile of process 1, which may occur via weekly events 160 spread over weeks 1-N. As shown, events 160 represent a weekly completion rate of approximately 4% per week at least through weeks 1-4. However, as is also shown in FIG. 1B, an accumulation of the effects of a progress profile reflecting completion of process events 160 of 4% over a 4-week period leads to bow wave event 170, which indicates that the contractor must make progress at a rate of more than 6% per week at week N, so as to reflect 100% completion of the process at week N. As noted previously herein, such bow wave events can be avoided via timely replanning/rescheduling via computer-implemented modeling of multi-event processes. Further, in particular embodiments, computer-implemented modeling of a multi-event process may facilitate the interactive real-time or near-real-time modeling of the events of a process, so as to warn a contractor and other concerned parties of an impending, and potentially unmanageable, bow wave of progress at week N.

With continued reference to FIG. 1B, predecessor event 180 may impact completion of events 160 of a scheduled process. In particular embodiments, predecessor event 180 may refer to one or more previous events of a process similar to process events 160. Accordingly, predecessor event 180 may refer to a percentage of a completion state of events similar to those of events 160. Thus, for example, predecessor event 180 may represent an accumulation of one or more events, such as excavating earth, similar to events 160 that may also pertain to excavating earth. In this context, predecessor event 180 may represent a plurality of past weekly events. For example, predecessor event 180 may indicate progress to date of excavation during several past weeks during a flood season, in which only marginal clean progress has been made toward excavating a total area or volume of earth that is to be excavated.

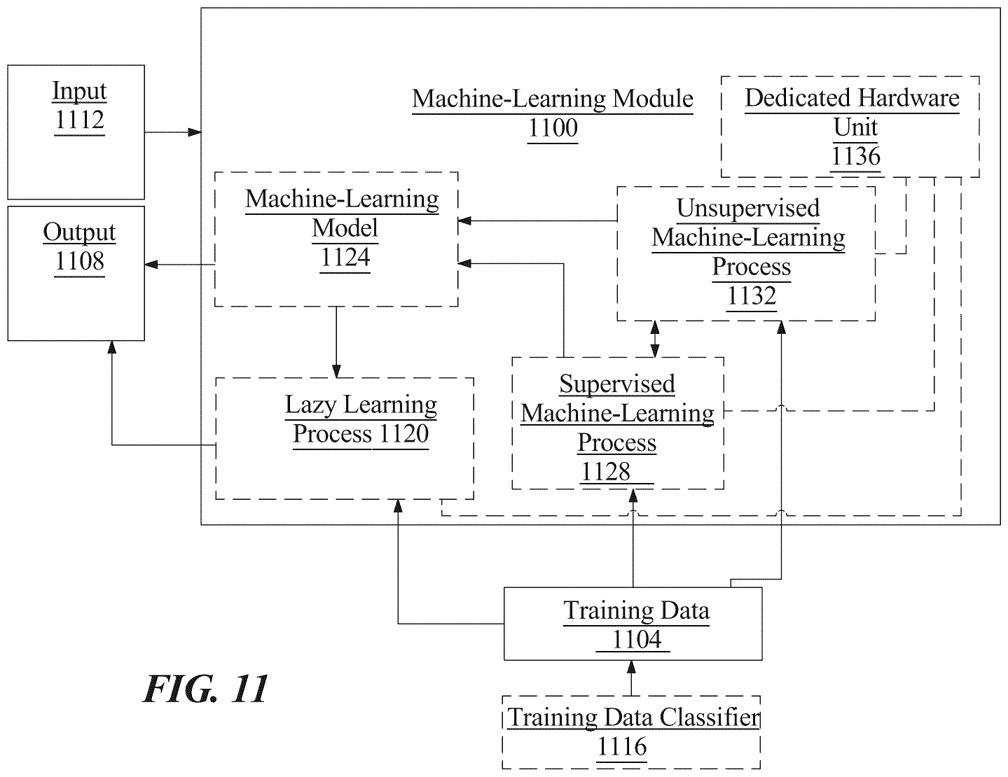

With continued reference to FIG. 1B, in some cases, computer-implemented modeling tool may incorporate one or more machine learning algorithms (as described in further detail with reference to FIG. 11 below) that analyze historical scheduling and performance data. In some embodiments, implementations of one or more machine learning algorithms may enable multi-event process models to learn from past project executions, identifying one or more scheduling/event progress patterns and correlations that may predict future scheduling i.e., second subset of events of plurality of events, events conflicts, resource needs, and/or the like. In a non-limiting example, training data containing project data related to a plurality of historical projects that involved one or more processes in questions, apparatus described herein may be configured to implement a machine learning model e.g., a random forest machine learning model using such training data. Thus, in a possible example, trained random forest machine learning model may be capable of analyzing various factors that influence project timelines such as, without limitation, weather patterns, crew size, equipment availability, among other potential factors. According to a particular embodiment, such machine learning model may have learned from, for example, previous projects that rainy seasons can delay the process of pouring of concrete for foundations, could proactively suggest or generate an adjustment or a set of adjustments (or an alternative schedule) to the calculated schedule or replace it. If, in some instances, the upcoming project timeline falls in a period known for high precipitation, computer-implemented modeling tool may automatically propose an earlier start time for a foundation work or recommend allocation of additional resources to maintain the timeline despite potential weather disruptions using machine learning models.

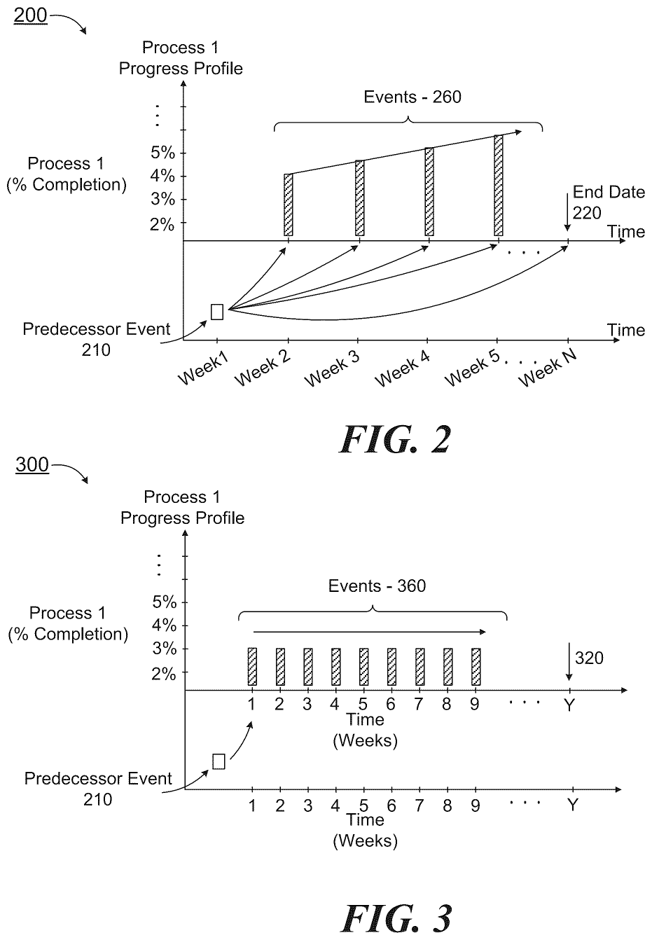

Now referring to FIG. 2, an exemplary embodiment of a graph 200 showing respreading of process events in response to delayed completion of a predecessor second event is illustrated. In this embodiment, events 260 represent a respreading of events 160 (of FIG. 1B). Such respreading operates to avoid bow wave 170 shown in FIG. 1B. Thus, as shown, in response to a contractor incrementally increasing a rate of progress of events 160, the contractor may avoid potentially unmanageable bow wave 170. In the example of FIG. 2, responsive to a contractor increasing the rate of progress of events 160, such as from approximately 3% at week 2 to approximately 5% at week 5, the contractor may be assured that the process that includes events 160 may be completed by an end date, given by arrow 220 at week N. Such increases in the rate of progress may be brought about by increasing a performance factor of events 160, which may include adding personnel and/or equipment resources, engaging a specialized sub-tier contractor, and so forth.

With continued reference to FIG. 2, additionally depicts predecessor event 210, which may refer to an event of a process that is different from a process encompassing events 160. For example, predecessor event 210 may refer to one or more inspections, which may be scheduled to occur prior to initiation of time-phased events 160. In one possible scenario, prior to excavation of material from a jobsite, one or more environmental impact studies may be scheduled for submittal and/or approval, which may delay excavation events 160. However, by way of a computer-implemented model of a multi-event process, a contractor, overseer, or other interested party, may visually represent a revised progress profile of events 160, so as to avoid bow wave 170 of FIG. 1B by increasing weekly progress by incremental amounts.

Now referring to FIG. 3, an exemplary embodiment of a graph 300 showing respreading of process events in response to delayed completion of two predecessor process events is illustrated. In FIG. 3, rather than increasing a rate of completion of time-phased process events, such as depicted in reference to FIG. 2, time-phased events 360 may be spread to reflect a completion rate of 3% per week over a duration of greater than 9-weeks. Such respreading of time-phased events over a longer duration (e.g., greater than 9-weeks) may avoid a need for an increased rate of completion of process events, which may be, at least in particular instances, difficult to achieve. However, such respreading of time-phased events, as shown, delays completion of events 360, in which a completion date has been moved to end date 320. It may be appreciated that such computer-implemented modeling of a multi-event process may be instrumental in providing real-time or near-real-time notification that a completion date for certain events may extend beyond the previously-scheduled completion date.

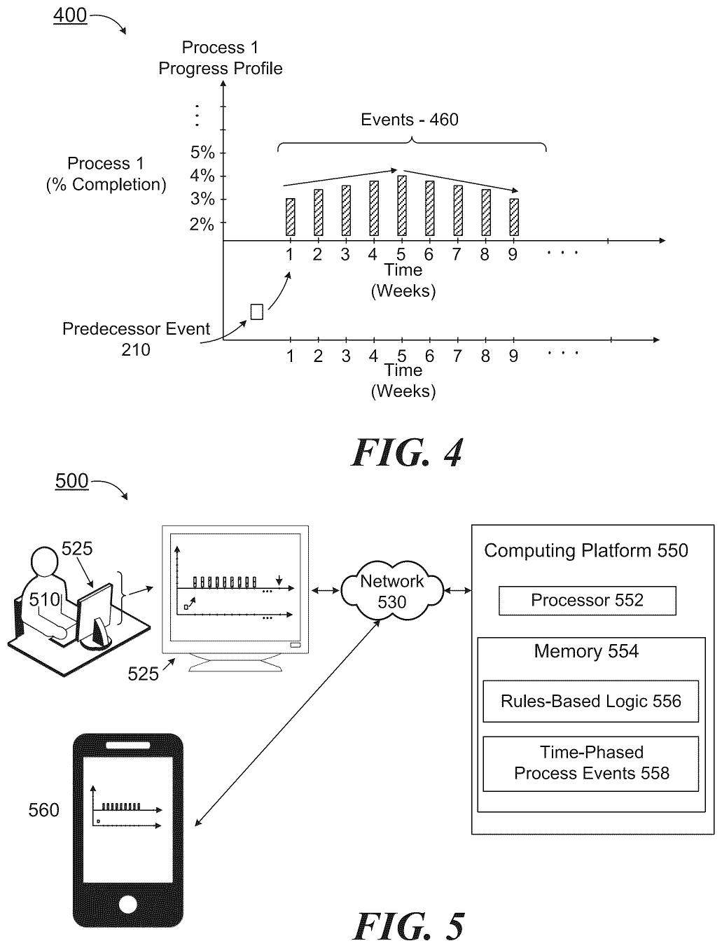

Now referring to FIG. 4, an exemplary embodiment of a graph 400 showing respreading of process events in response to completion of a predecessor event, in which process completion rates are first increased and then later decreased, is illustrated. Thus, as indicated in FIG. 4, a completion rate of time-phased events 460 may be scheduled to increase from a completion rate of approximately 3% per week at week 1 to a completion rate of approximately 4% at week 5 before returning to a completion rate of approximately 3% at week 9.

Now referring to FIG. 5 a schematic diagram 500 showing a user interacting with a user interface to utilize a computer-implemented model of a multi-event process is illustrated. In FIG. 5, user 510 may interact with computing platform 550, such as via intervening network 530, to perform real-time or near-real-time replanning and/or rescheduling events of a particular process of the multi-event process. Accordingly, user 510 may generate, for example, numerous formal or informal speculations based on virtually any number of scenarios, for example, in completing scheduled events of a multi-event process. Display device 525 may operate to display visual representations of any graphs previously discussed with respect to FIG. 1-4 herein. In addition, display device 555 may permit user 510 to select to display visual representations of graphs graduated to show time-phased events representing daily progress, weekly progress, monthly progress, or any other user-selectable graduation of time-based events, and claimed subject matter is not limited in this respect.

It should be noted that Although FIGS. 1-5 relate to computer-implemented models of a multi-process event within the context of a construction project, it may be appreciated that such embodiments, or other embodiments, may relate to a variety of other industries. For example, within a financial context, an individual or an entity may allocate certain financial resources in accordance with an originally-proposed set of time-phased events, such as $1000 per month. However, in the event that actual allocations (e.g., one or more predecessor events) fall short (e.g., allocating only $750 per month) a computer-implemented model may alert a financial officer, for example, that monthly allocation events are to be increased in order to reach an end goal that relates to a total allocation of financial resources. In another example, with respect to a business entity engaged in selling products, an originally proposed sales schedule may forecast sales of 1000 units per month. However, responsive to actual sales (predecessor events) falling short of forecast sales (e.g., sales of only 500 units per month) a sales manager may be alerted so as to increase sales efforts over future months so as to realize particular sales of total units by a future date.

Computing platform 550 of FIG. 5 may comprise one or more of processor 552, which may be communicatively coupled to one or more memory devices, such as memory 554. Memory 554 may comprise a memory array, such as a two- or three-dimensional memory array, which may be loaded so as to implement rules-based logic 556. Rules-based logic 556 may operate to link various time-phased process events, such as time-based process events 558. In particular embodiments, processor 552 may execute a computer program to implement a spreadsheet application so as to facilitate display and/or evaluation of virtually any number of originally proposed or respread process events, such as those described previously herein.

In an embodiment, user 510 may interact with a spreadsheet application operating on mobile device 560, which may facilitate the same or similar interactions performed via a user interface of computing platform 550. Thus, mobile device 560 may cooperate with computing platform 550 to implement rules-based logic to display originally proposed and/or respread events of a multi-event process. In another embodiment, mobile device 560 may include a suitable processor coupled to a memory device to implement rules-based logic to display original and/or respread events in a standalone manner, such as without aid or cooperation with computing platform 550.

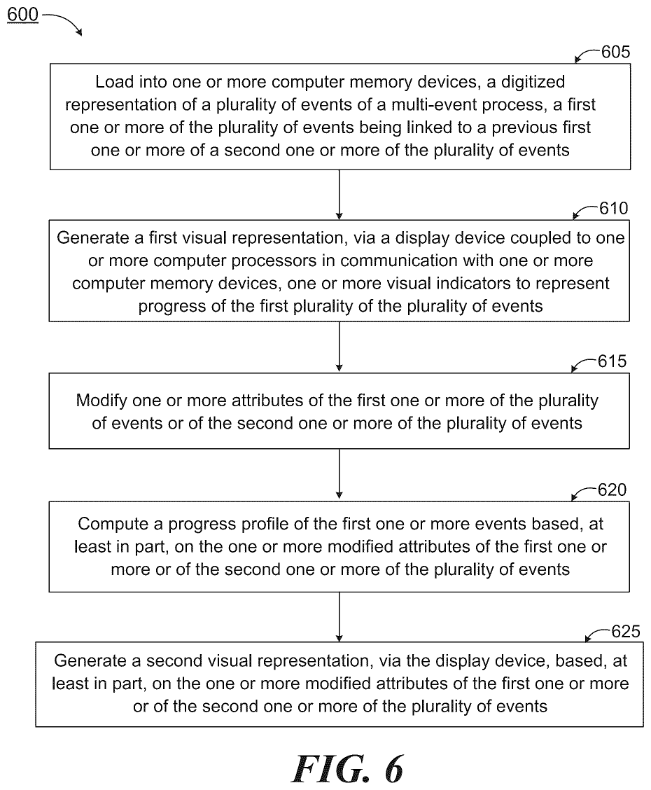

Now referring to FIG. 6, a flowchart for a method 600 for computer-implemented modeling of a multi-event process is illustrated. Embodiments in accordance with claimed subject matter may include all of the actions depicted at 605-625, fewer actions than those depicted at 605-625 and/or more actions than those depicted at 605-625. Likewise, it should be noted that content acquired or produced, such as, for example, input signals, output signals, operations, results, etc., brought about by the example process of embodiment 600 may be represented via one or more digital signals and/or digital signal states. It should also be appreciated that even though one or more operations are illustrated or described concurrently or with respect to a certain sequence, other sequences or concurrent operations may be performed. In addition, although the description below references particular aspects and/or features illustrated in certain other figures, one or more operations may be performed with other aspects and/or features. In embodiments, blocks 605-625 may be communicated as one or more signals and/or signal packets among various software, firmware and/or hardware services executed at a computing device, such as computing platform 550.

With continued reference to FIG. 6, method 600 may begin at 605, which may include loading into one or more computer memory devices, a digitized representation of a plurality of events of a multi-event of process. A first sub-set of events are linked to a sub-set of previous (historical) events. Alternatively, at 605, first sub-set of events may be linked to a second sub-set of events of the plurality of events. The method 600 may continue at 610, which may include generating a first visual representation, such as via a display device coupled to one or more computer processors in communication with one or more computer memory devices, one or more visual indicators to represent progress of the first plurality of the plurality of events.

With continued reference to FIG. 6, in some embodiments, first visual representation and second visual representation may be determined as a first visual representation data structure and a second visual representation data structure, respectively. A “visual representation data structure,” for the purposes of this disclosure, is a data structure containing information relating to a visual representation, wherein the data structure is configured to cause a remote device to display the visual representation. In some embodiments, visual representation data structures may include code such as CSS or HTML. In some embodiments, visual representation data structures may include one or more event handlers, wherein the event handlers are configured to execute code in response to a given event. In some embodiments, first and/or second visual representation data structures may be transmitted to one or more remote devices.

With continued reference to FIG. 6, method 600 may continue at 615, which may include modifying one or more event attributes of the first one or more of the plurality of events or of the second of the one or more of the plurality of events. The method 600 may continue at 620, which may include computing an event progress profile of the first one or more events based, at least in part, on the one or more modified event attributes (e.g., as modified in accordance with 615) of the first one or more, or of the second one or more, of the plurality of events. The method may continue at 625, which may include generating a second visual representation, via the display device, based, at least in part, on the one or more modified attributes of the first one or more or of the second one or more of the plurality of events.

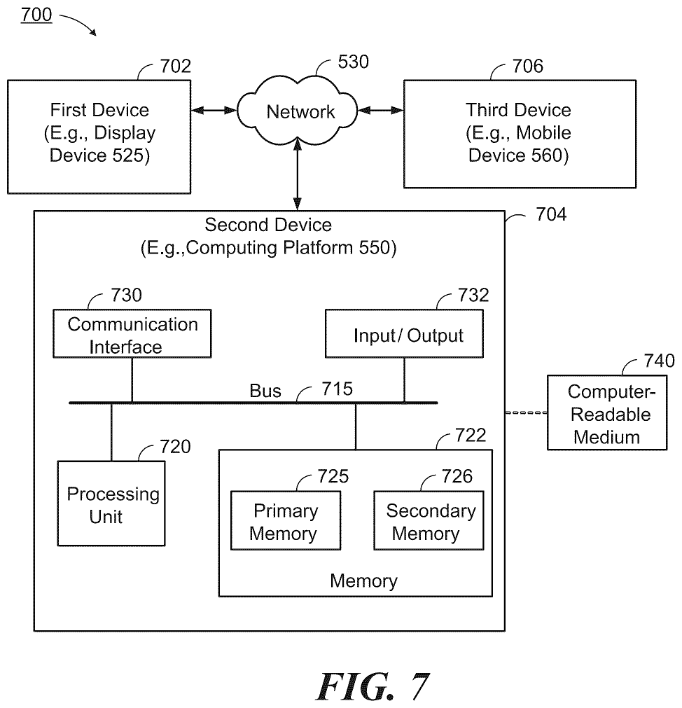

Now referring to FIG. 7, a schematic block diagram illustrating a computing environment 700 to facilitate computer-implemented modeling of a multi-event process is illustrated. In the embodiment of FIG. 7, first device 702 may comprise a computer user interface and a display device, such as display device 525 of FIG. 5. Second device 704, may comprise, for example, computing platform 550, which may permit the user to interact with a spreadsheet program, for example, to facilitate modeling of a multi-event process. Third device 706 may comprise a mobile device, such as mobile device 560, which may include a user interface, a computer processor, and one or more computer memory devices, to allow the user, such as user 510, to interact with a spreadsheet program, for example, which may facilitate modeling of a multi-event process. Network 530 may comprise any type of ethernet, LAN, or Internet-based computing network, similar to network 530 of FIG. 5. Processing unit 720 and memory 722, which may comprise primary memory 725 and secondary memory 726, may communicate by way of a communication interface 730, for example, and/or input/output module 732. The terms “computing device,” “computing platform,” or “computing resource” in the context of the present application, refer to a system and/or a device, such as a computing apparatus that includes a capability to process (e.g., perform computations) and/or store digital content, such as electronic files, electronic documents, text, images, video, audio, etc., in the form of signals and/or signal states. Thus, a computing platform, in the setting or environment of the present patent application, may comprise hardware, software, firmware, or any combination thereof (other than software per se). Computing device 704 (e.g., second device), as depicted in FIG. 7, is merely one example, and claimed subject matter is not limited in scope to this particular example.

With continued reference to FIG. 7, computing device includes a processor communicatively connected to a memory. As used in this disclosure, “communicatively connected” means connected by way of a connection, attachment or linkage between two or more relata which allows for reception and/or transmittance of information therebetween. For example, and without limitation, this connection may be wired or wireless, direct or indirect, and between two or more components, circuits, devices, systems, and the like, which allows for reception and/or transmittance of data and/or signal(s) therebetween. Data and/or signals therebetween may include, without limitation, electrical, electromagnetic, magnetic, video, audio, radio and microwave data and/or signals, combinations thereof, and the like, among others. A communicative connection may be achieved, for example and without limitation, through wired or wireless electronic, digital or analog, communication, either directly or by way of one or more intervening devices or components. Further, communicative connection may include electrically coupling or connecting at least an output of one device, component, or circuit to at least an input of another device, component, or circuit. For example, and without limitation, via a bus or other facility for intercommunication between elements of a computing device. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure.

With continued reference to FIG. 7, first device 702, second device 704, and third device 706 may provide one or more sources of executable computer instructions in the form of physical states and/or signals (e.g., stored in memory states), for example. First device 702 may communicate with second device 704 by way of a network connection, such as via network 530 as previously mentioned, for example. It may be appreciated that a connection, while physical, may be virtual and not necessarily be tangible. Although second device 704 of FIG. 7 depicts various tangible, physical components, claimed subject matter is not limited to a computing devices having only these tangible components as other implementations and/or embodiments may include alternative arrangements that may comprise additional tangible components or fewer tangible components, for example, that function differently while achieving similar results. Rather, examples are provided merely as illustrations. It is not intended that claimed subject matter be limited in scope to illustrative examples.

With continued reference to FIG. 7, memory 722 may comprise any non-transitory storage device or system of devices. Memory 722 may comprise, for example, primary memory 725 and secondary memory 726, additional memory circuits, mechanisms, or combinations thereof may be used. Memory 722 may comprise, for example, random access memory, read only memory, etc., such as in the form of one or more storage devices and/or systems, such as, for example, a disk drive including an optical disc drive, a tape drive, a solid-state memory drive, etc., just to name a few examples.

Continuing reference to FIG. 7, memory 722 may comprise one or more articles utilized to store a program of executable computer instructions. For example, processing unit 720 may fetch executable instructions from memory and proceed to execute the fetched instructions. Memory 722 may also comprise a memory controller for accessing computer-readable medium 740 that may carry and/or make accessible digital content, which may include code, and/or instructions, for example, executable by processing unit 720 and/or any other device, such as a controller, as one example, capable of executing computer instructions, for example. Under direction of processing unit 720, a non-transitory memory, such as memory cells storing physical states (e.g., memory states), comprising, for example, a program of executable computer instructions, may be executed by processing unit 720 and be capable of generating signals to be communicated via a network, for example, as previously described. Generated signals, and/or signal states, may also be stored in memory, also previously suggested.

With continued reference to FIG. 7, memory 722 may store electronic files and/or electronic documents, such as relating to one or more users, and may also comprise a machine-readable medium that may carry and/or make accessible content, including code and/or instructions, for example, executable by processing unit 720 and/or any other type of programmable device, such as a controller, as one example, capable of executing computer instructions, for example. As previously mentioned, the term electronic file and/or the term electronic document are used throughout this document to refer to a set of stored memory states and/or a set of physical signals associated in a manner so as to thereby form an electronic file and/or an electronic document, such as a spreadsheet. That is, it is not meant to implicitly reference a particular syntax, format and/or approach used, for example, with respect to a set of associated memory states and/or a set of associated physical signals. It may be appreciated that an association of memory states, for example, may be in a logical sense and not necessarily in a tangible, physical sense. Thus, although signal and/or state components of an electronic file and/or electronic document, are to be associated logically, storage thereof, for example, may reside in one or more different places in a tangible, physical memory, in an embodiment.

With continued reference to FIG. 7, Example devices may comprise features, for example, of a client computing device and/or a remote/server computing device, in an embodiment. It is further noted that the term computing device, in general, whether employed as a client and/or as a server, or otherwise, refers at least to a processor and a memory connected by communications bus 715. A “processor,” such as a processor of a computing platform, for example, is understood to refer to a specific structure such as a central processing unit (CPU) of a computing device which may include a control unit and an execution unit. In an aspect, a processor may comprise a device that interprets and executes instructions to process input signals to provide output signals. As such, in the context of the present patent application at least, computing device and/or processor are understood to refer to sufficient structure within the meaning of 35 USC § 112 (f) so that it is specifically intended that 35 USC § 112 (f) not be implicated by use of the term “computing device,” “processor,” “computing platform,” and/or similar terms; however, if it is determined, for some reason not immediately apparent, that the foregoing understanding cannot stand and that 35 USC § 112 (f), therefore, necessarily is implicated by the use of the term “computing device,” “processor,” computing platform,” and/or similar terms, then, it is intended, pursuant to that statutory section, that corresponding structure, material and/or acts for performing one or more functions be understood and be interpreted to be described in the figures shown and described herein.

With continued reference to FIG. 7, Processor may include any computing device as described in this disclosure, including without limitation a microcontroller, microprocessor, digital signal processor (DSP) and/or system on a chip (SoC) as described in this disclosure. Processor may include, be included in, and/or communicate with a mobile device such as a mobile telephone or smartphone. Processor may include a single computing device operating independently, or may include two or more computing device operating in concert, in parallel, sequentially or the like; two or more computing devices may be included together in a single computing device or in two or more computing devices. Processor may interface or communicate with one or more additional devices as described below in further detail via a network interface device. Network interface device may be utilized for connecting processor to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Processor may include but is not limited to, for example, a computing device or cluster of computing devices in a first location and a second computing device or cluster of computing devices in a second location. Processor may include one or more computing devices dedicated to data storage, security, distribution of traffic for load balancing, and the like. Processor may distribute one or more computing tasks as described below across a plurality of computing devices of computing device, which may operate in parallel, in series, redundantly, or in any other manner used for distribution of tasks or memory between computing devices. Processor may be implemented, as a non-limiting example, using a “shared nothing” architecture.

With continued reference to FIG. 7, processor may be designed and/or configured to perform any method, method step, or sequence of method steps in any embodiment described in this disclosure, in any order and with any degree of repetition. For instance, processor may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Processor may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

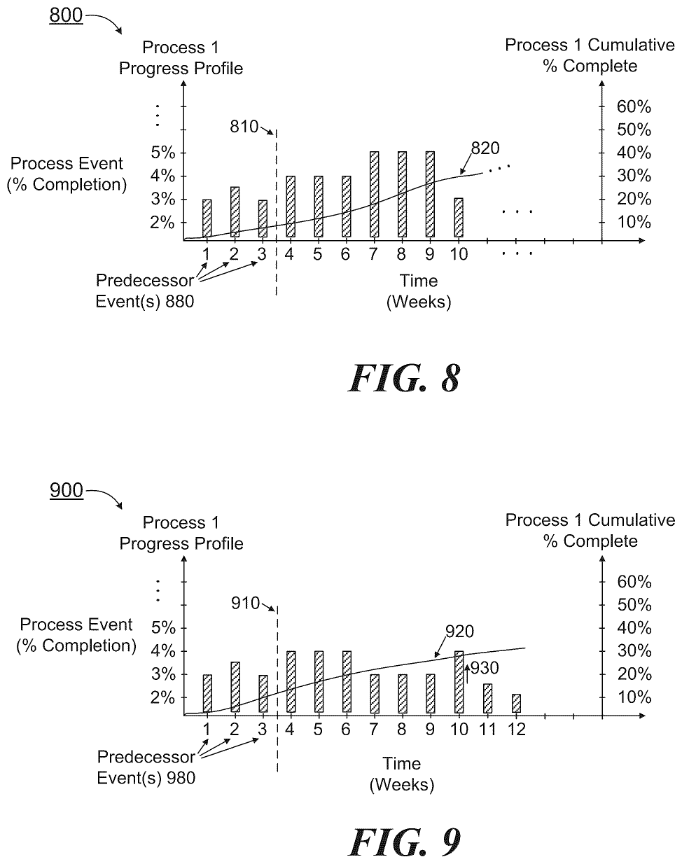

Now referring to FIG. 8, a first exemplary embodiment of a graph 800 showing respreading of process events in response to linking of a computer-implemented model for a multi-event process with a computer-implemented calendaring tool. In the embodiment of FIG. 8, predecessor events 880 of a multi-event process are indicated as being prior to dotted line 810, which separates preceding (actual) events from events scheduled to occur during a future duration. A progress profile of process 1 (in percentages) is indicated at the vertical axis at the left side of FIG. 8, and a measure of cumulative progress toward completion is indicated at the vertical axis at the right side of FIG. 8. Line 820 indicates a measure of cumulative progress so as to account for incremental (e.g., weekly) progress toward completion of process 1.

With continued reference to FIG. 8, events occurring at weeks 4, 5, and 6 may be constrained to correspond to a completion rate of 4% per week. Additionally, events occurring at weeks 7, 8, and 9 may be constrained to correspond to a completion rate of 5% per week. In particular embodiments, such constraints may be realized by linking, for example, a computer-implemented spreadsheet with a computer-implemented calendaring tool. In such a scenario, in view of constraints placed upon rates of completion at weeks 4-7, a computer-implemented model of a multi-event process may respread events beginning at week 10, so as to indicate a desired a cumulative completion of approximately 30% at week 10 and beyond. It may be appreciated that such linking of a computer-implemented spreadsheet with a calendaring tool may facilitate generation of a respread progress profile that permits the user (e.g., user 510 of FIG. 5) to impart a particular shape or form to line 820 in a way that may be useful to a contractor or to a contracting officer, a customer, or other overseer. In addition, respreading of events of a progress profile may be computed and/or represented to show increasing rates of progress over time (e.g., “ramp up”) as well as decreasing rates of progress (e.g., “ramp down”). Moreover, responsive to establishing rules-based logic, such as via rules-based logic 556 of FIG. 5, a user may be able to establish logical links between calendaring events and time-phased events.

Table 1 (below) depicts entries to a computer-implemented spreadsheet showing weekly progress events linked to a computer-implemented calendaring program to indicate a contractor performance Index (CPI) of 1.0 as a spread among weeks 4-9.

TABLE 1

| CPI Adjustment | Week 4 | Week 5 | Week 6 | Week 7 | Week 8 | Week 9 |
|---|---|---|---|---|---|---|
| 1.0 | 4.0% | 4.0% | 4.0% | | | |
| 1.0 | | | | 5.0% | 5.0% | 5.0% |

Now referring to FIG. 9, a second exemplary embodiment of a graph 900 showing respreading of process events in response to linking of a computer-implemented model for a multi-event process with a computer-implemented calendaring tool is illustrated. In the embodiment of FIG. 9, predecessor events of a multi-event process are indicated as being prior to dotted line 910, which separates preceding (actual) events from events scheduled to occur during a future duration. A progress profile of process 1 (in percentages) is indicated at the vertical axis at the left side of FIG. 9, and a measure of cumulative progress toward completion is indicated at the vertical axis at the right side of FIG. 9. Line 920 indicates a measure of cumulative progress so as to account for incremental (e.g., weekly) progress toward completion of process 1.

With continued reference to FIG. 9, events occurring at weeks 4, 5, and 6 may be constrained to correspond to a completion rate of 4% per week. Additionally, events occurring at weeks 7, 8, and 9 may be constrained to correspond to a completion rate of 3% per week. In particular embodiments, such constraints may be realized via linking, for example, a computer-implemented implemented spreadsheet with a computer-implemented calendaring tool. In such a scenario, in view of constraints placed upon rates of completion at weeks 4-9, a computer-implemented model of a multi-event process may respread events beginning at week 10, to achieve a desired a cumulative completion of approximately 30% at week 12. In the embodiment of FIG. 9, in response to constraining completion rates at weeks 4-9, a computer-implemented model may respread events beginning at week 10 and decreasing (e.g., ramping down) at weeks 10, 11, and 12.

With continued reference to FIG. 9, in addition, a computer-implemented model for a multi-event process utilizing a computerized spreadsheet may apply a CPI having values other than 1.0, as shown in Table 1 (above). Accordingly, as indicated in Table 2 (below), a CPI of 0.75 may be applied to reduce expected actual progress to accord with a CPI of below 1.0, so as to account for, for example, an anticipated adverse weather impact, holiday, or other occurrence that operates to reduce a weekly progress rate of a particular process event. Thus, as shown in Table 2 (below) similar to a CPI at weeks 4, 5, and 6 shown in Table 1 (without expected weather delays), for example, a contractor may schedule progress in accordance with a CPI of 1.0. However, in anticipation of a scheduled local holiday, a progress profile of weekly events occurring at weeks 7, 8, and 9 a CPI may be reduced from 1.0 to, for example, 0.75. Thus, as indicated in Table 2 below, and in FIG. 9, a progress profile of events occurring at weeks 7, 8, and 9 is indicated as being reduced to 3%.

TABLE 2

| CPI Adjustment | Week 4 | Week 5 | Week 6 | Week 7 | Week 8 | Week 9 |
|---|---|---|---|---|---|---|
| 1.0 | 4.0% | 4.0% | 4.0% | | | |
| 0.75 | | | | 3.0% | 3.0% | 3.0% |

Continuing reference to FIG. 9, in addition, FIG. 9 indicates that responsive to a reduction in a CPI from 1.0 to 0.75, a weekly progress rate of an event occurring at week 10 may be indicated as increasing, as shown by arrow 930. A progress rate of the event may then ramp down, such as indicated with respect to weeks 11 and 12. It may be appreciated that responsive to a reduced CPI at weeks 7-9, a period of performance may be extended into weeks 11 and 12 (and perhaps beyond).

With continued reference to FIG. 9, additionally, or alternatively, respreading of progress events i.e., events subsequent to predecessor events 980 may include a utilization of an “event attribute modifier,” wherein the “event attribute modifier,” for the purpose of this disclosure, a feature or a set of features in computing platform 550 that allows a user to change event attributes associated with events within a schedule. In one or more embodiments, event attribute modifier may control one or more event attributes associated with one or more events, for example, event attributes may be controlled may include, but are not limited to, the start and end dates of one or more events, progress status, event dependencies, and other parameters.

Still referring to FIG. 9, event attribute modifier may include, according to a particular embodiment, a linear element such as a linear a graphical user interface element within the user interface. In some cases, such linear graphical user interface element may include, without limitation, a slider bar, dropdown menu, or a input field. In a non-limiting example, event attribute modifier may be embodied as a linear element that is designed with a first interactive end and a second interactive end, corresponding respectively to a changeable start time of a first event and a changeable end date of a second event. In some cases, first interactive end may also correspond to a changeable end date of a predecessor event. User may actively manipulate the linear element to adjust the scheduling of events. In some cases, user may move the slider bidirectionally until the respread event progress matches historical data points. Such alignment may signify that the adjusted forecast for the project mirrors the level of work and progress rates achieved in previous projects under similar conditions.

With continued reference to FIG. 9, in a non-limiting example, in some cases, project that is scheduled across week 1 to week 10 (as shown in FIG. 8) may project a 25% completion by week 10 due to unexpected delays in predecessor events 880. Thus, in a possible example, user may use slider bar within the computer-implemented tool to adjust event attributes of events for week 4 to 10. In some cases, slider bar presented on the user interface may include a first interactive end represent the start time of event at week 4 (i.e., process 4) and a second interactive end represents the end date (initially set at week 10) of the project. User may drag the second interactive end of the slider bar outward, extending the end date of the project. As the slider moves, multi-event process model may recalculate the completion rate needed each week to meet 30% milestone by week 12 (as shown in FIG. 9). User may continue to adjust slider bar and the visual representation may dynamically update according to the adjustment. In an embodiment, line representing the cumulative progress (line 920) may alters its trajectory, ramping up to meet historical completion rate. Once the slider bar is released, multi-event process model may lock in the new end date, and a second visual representation may be generated to reflect an adjusted schedule where progress of events of subsequent weeks is flattened (due to an increase in week numbers).

With further referring to FIG. 9, additionally, or alternatively, in scenarios where project constraints dictate, for example, a maximum allowable resource level, event attribute modifier may be utilized to ensure that the project schedule adheres to such limitations. In a non-limiting example, if a construction project area can only accommodate a maximum of 50 workers at any given time, and the current schedule indicates a requirement for 75 workers, user may use slider bar to adjust project timeline accordingly by slide second interactive end (finish date) outward, multi-event process model may recalculate the distribution of work such that at no points does the worker requirement exceed the maximum capacity of 50 works. Thus, this respreading of events may, in turn, indicate a more realistic duration for each event given the resource constraints.

Continuing reference to FIG. 9, according to an alternative embodiment, computer-implemented model for multi-event process may provide one or more input fields wherein user may specify one or more event limitations or constraints such as, without limitation, maximum number of workers. In some cases, upon entry, the multi-event process model may automatically extend the end date of one or more events in question until the calculated requirement for workers does not surpass the maximum input. In some cases, such feature may automate the process of verifying a compliance with project resource constraints, thereby streamlining project scheduling and management. Additionally, apparatus described herein may incorporate probability ranges into the multi-event process model; for instance, if there is a 90% probability (P90) that the project can efficiently manage 40 workers, such figure may be entered, by a user, into the computer-implemented tool as a maximum constraint. Similarly, a 50% probability (P50) may correspond to 50 workers, and a 10% probability (P10) to 60 workers. In this case, multi-event process model may use these probability inputs to automatically adjust the project schedule, displaying different potential completion dates (P90, P50, and P10 dates) for each probability level

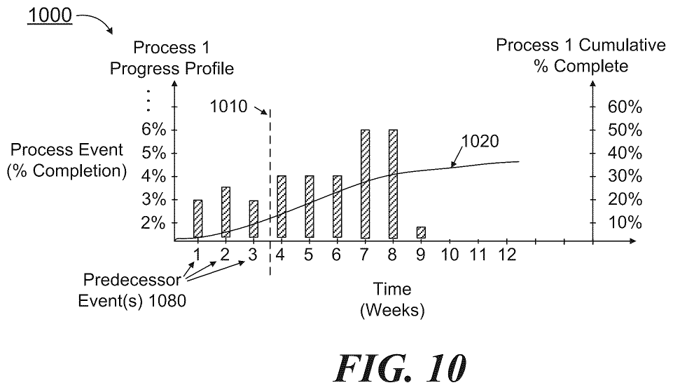

Now referring to FIG. 10, a third exemplary embodiment of a graph 1000 showing respreading of process events in response to linking of a computer-implemented model for a multi-event process with a computer-implemented calendaring tool is illustrated. In the embodiment of FIG. 10, predecessor events 1080 of a multi-event process are indicated as being prior to dotted line 1010, which separates preceding (actual) events from events scheduled to occur during a future duration. A progress profile of process 1 (in percentages) is indicated at the vertical axis at the left side of FIG. 10, and a measure of cumulative progress toward completion is indicated at the vertical axis at the right side of FIG. 10. Line 1020 indicates a measure of cumulative progress so as to account for incremental (e.g., weekly) progress toward completion of process 1.

With continued reference to FIG. 10, events occurring at weeks 4, 5, and 6 may be constrained to correspond to a completion rate of 4% per week. Additionally, events occurring at weeks 7 and 8 may be constrained to correspond to a completion rate of 6% per week. In particular embodiments, such constraints may be realized by linking, for example, a computer-implemented spreadsheet with a computer-implemented calendaring tool. In such a scenario, in view of constraints placed upon rates of completion at weeks 4-7, a computer-implemented model of a multi-event process may respread events beginning at week 10, to achieve a desired a cumulative completion of approximately 30% at week 12. In the embodiment of FIG. 10, in response to constraining completion rates at weeks 4-8, a computer-implemented model may respread events, such as to indicate that only a small amount of progress needs to be made at week 9 to achieve a 30% at week 10.

With continued reference to FIG. 10, in addition, a computer-implemented model for a multi-event process utilizing a computerized spreadsheet may employ a CPI having values other than 1.0. Accordingly, as indicated in Table 3 (below), a CPI of 1.2 may be applied to increase expected actual progress to a value greater than 1.0, to account for, for example, an effect of bringing on an additional shift, such as a swing shift or a night shift, so as to increase weekly progress of events of a particular process event. As shown in Table 3, similar to a CPI at weeks 4, 5, and 6 shown in Table 1, a contractor may schedule progress in accordance with a CPI of 1.0. However, to account for effects of adding a night shift or swing shift to complete events of a multi-event process, a progress profile of weekly events occurring at weeks 7 and 8, CPI may be increased from 1.0 to, for example, 1.2. As indicated in FIG. 10, a progress profile of a respread event occurring at week 9 is indicated as being reduced to less than 2%.

TABLE 3

| CPI Adjustment | Week 4 | Week 5 | Week 6 | Week 7 | Week 8 |
|---|---|---|---|---|---|
| 1.0 | 4.0% | 4.0% | 4.0% | | |
| 1.2 | | | | 6.0% | 6.0% |

Referring now to FIG. 11, an exemplary embodiment of a machine-learning module 1100 that may perform one or more machine-learning processes as described in this disclosure is illustrated. Machine-learning module may perform determinations, classification, and/or analysis steps, methods, processes, or the like as described in this disclosure using machine learning processes. A “machine learning process,” as used in this disclosure, is a process that automatedly uses training data 1104 to generate an algorithm instantiated in hardware or software logic, data structures, and/or functions that will be performed by a computing device/module to produce outputs 1108 given data provided as inputs 1112; this is in contrast to a non-machine learning software program where the commands to be executed are determined in advance by a user and written in a programming language.

Still referring to FIG. 11, “training data,” as used herein, is data containing correlations that a machine-learning process may use to model relationships between two or more categories of data elements. For instance, and without limitation, training data 1104 may include a plurality of data entries, also known as “training examples,” each entry representing a set of data elements that were recorded, received, and/or generated together; data elements may be correlated by shared existence in a given data entry, by proximity in a given data entry, or the like. Multiple data entries in training data 1104 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 1104 according to various correlations; correlations may indicate causative and/or predictive links between categories of data elements, which may be modeled as relationships such as mathematical relationships by machine-learning processes as described in further detail below. Training data 1104 may be formatted and/or organized by categories of data elements, for instance by associating data elements with one or more descriptors corresponding to categories of data elements. As a non-limiting example, training data 1104 may include data entered in standardized forms by persons or processes, such that entry of a given data element in a given field in a form may be mapped to one or more descriptors of categories. Elements in training data 1104 may be linked to descriptors of categories by tags, tokens, or other data elements; for instance, and without limitation, training data 1104 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively or additionally, and continuing to refer to FIG. 11, training data 1104 may include one or more elements that are not categorized; that is, training data 1104 may not be formatted or contain descriptors for some elements of data. Machine-learning algorithms and/or other processes may sort training data 1104 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 1104 to be made applicable for two or more distinct machine-learning algorithms as described in further detail below. Training data 1104 used by machine-learning module 1100 may correlate any input data as described in this disclosure to any output data as described in this disclosure. As a non-limiting illustrative example training data may include a plurality of historical project data as input correlated to a plurality of schedules/adjustments as output.

Further referring to FIG. 11, training data may be filtered, sorted, and/or selected using one or more supervised and/or unsupervised machine-learning processes and/or models as described in further detail below; such models may include without limitation a training data classifier 1116. Training data classifier 1116 may include a “classifier,” which as used in this disclosure is a machine-learning model as defined below, such as a data structure representing and/or using a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. A distance metric may include any norm, such as, without limitation, a Pythagorean norm. Machine-learning module 1100 may generate a classifier using a classification algorithm, defined as a processes whereby a computing device and/or any module and/or component operating thereon derives a classifier from training data 1104. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers.

Still referring to FIG. 11, computing device 1104 may be configured to generate a classifier using a Naïve Bayes classification algorithm. Naïve Bayes classification algorithm generates classifiers by assigning class labels to problem instances, represented as vectors of element values. Class labels are drawn from a finite set. Naïve Bayes classification algorithm may include generating a family of algorithms that assume that the value of a particular element is independent of the value of any other element, given a class variable. Naïve Bayes classification algorithm may be based on Bayes Theorem expressed as P(A/B)=P(B/A) P(A)÷P(B), where P(A/B) is the probability of hypothesis A given data B also known as posterior probability; P(B/A) is the probability of data B given that the hypothesis A was true; P(A) is the probability of hypothesis A being true regardless of data also known as prior probability of A; and P(B) is the probability of the data regardless of the hypothesis. A naïve Bayes algorithm may be generated by first transforming training data into a frequency table. Computing device 1104 may then calculate a likelihood table by calculating probabilities of different data entries and classification labels. Computing device 1104 may utilize a naïve Bayes equation to calculate a posterior probability for each class. A class containing the highest posterior probability is the outcome of prediction. Naïve Bayes classification algorithm may include a gaussian model that follows a normal distribution. Naïve Bayes classification algorithm may include a multinomial model that is used for discrete counts. Naïve Bayes classification algorithm may include a Bernoulli model that may be utilized when vectors are binary.

With continued reference to FIG. 11, computing device 1104 may be configured to generate a classifier using a K-nearest neighbors (KNN) algorithm. A “K-nearest neighbors algorithm” as used in this disclosure, includes a classification method that utilizes feature similarity to analyze how closely out-of-sample-features resemble training data to classify input data to one or more clusters and/or categories of features as represented in training data; this may be performed by representing both training data and input data in vector forms, and using one or more measures of vector similarity to identify classifications within training data, and to determine a classification of input data. K-nearest neighbors algorithm may include specifying a K-value, or a number directing the classifier to select the k most similar entries training data to a given sample, determining the most common classifier of the entries in the database, and classifying the known sample; this may be performed recursively and/or iteratively to generate a classifier that may be used to classify input data as further samples. For instance, an initial set of samples may be performed to cover an initial heuristic and/or “first guess” at an output and/or relationship, which may be seeded, without limitation, using expert input received according to any process as described herein. As a non-limiting example, an initial heuristic may include a ranking of associations between inputs and elements of training data. Heuristic may include selecting some number of highest-ranking associations and/or training data elements.

With continued reference to FIG. 11, generating k-nearest neighbors algorithm may generate a first vector output containing a data entry cluster, generating a second vector output containing an input data, and calculate the distance between the first vector output and the second vector output using any suitable norm such as cosine similarity, Euclidean distance measurement, or the like. Each vector output may be represented, without limitation, as an n-tuple of values, where n is at least two values. Each value of n-tuple of values may represent a measurement or other quantitative value associated with a given category of data, or attribute, examples of which are provided in further detail below; a vector may be represented, without limitation, in n-dimensional space using an axis per category of value represented in n-tuple of values, such that a vector has a geometric direction characterizing the relative quantities of attributes in the n-tuple as compared to each other. Two vectors may be considered equivalent where their directions, and/or the relative quantities of values within each vector as compared to each other, are the same; thus, as a non-limiting example, a vector represented as [5, 10, 15] may be treated as equivalent, for purposes of this disclosure, as a vector represented as [1, 2, 3]. Vectors may be more similar where their directions are more similar, and more different where their directions are more divergent; however, vector similarity may alternatively or additionally be determined using averages of similarities between like attributes, or any other measure of similarity suitable for any n-tuple of values, or aggregation of numerical similarity measures for the purposes of loss functions as described in further detail below. Any vectors as described herein may be scaled, such that each vector represents each attribute along an equivalent scale of values. Each vector may be “normalized,” or divided by a “length” attribute, such as a length attribute l as derived using a Pythagorean norm: l=\sqrt{Σᵢ₌₀ⁿaᵢ²}, where aᵢ is attribute number i of the vector. Scaling and/or normalization may function to make vector comparison independent of absolute quantities of attributes, while preserving any dependency on similarity of attributes; this may, for instance, be advantageous where cases represented in training data are represented by different quantities of samples, which may result in proportionally equivalent vectors with divergent values.

With further reference to FIG. 11, training examples for use as training data may be selected from a population of potential examples according to cohorts relevant to an analytical problem to be solved, a classification task, or the like. Alternatively or additionally, training data may be selected to span a set of likely circumstances or inputs for a machine-learning model and/or process to encounter when deployed. For instance, and without limitation, for each category of input data to a machine-learning process or model that may exist in a range of values in a population of phenomena such as images, user data, process data, physical data, or the like, a computing device, processor, and/or machine-learning model may select training examples representing each possible value on such a range and/or a representative sample of values on such a range. Selection of a representative sample may include selection of training examples in proportions matching a statistically determined and/or predicted distribution of such values according to relative frequency, such that, for instance, values encountered more frequently in a population of data so analyzed are represented by more training examples than values that are encountered less frequently. Alternatively or additionally, a set of training examples may be compared to a collection of representative values in a database and/or presented to a user, so that a process can detect, automatically or via user input, one or more values that are not included in the set of training examples. Computing device, processor, and/or module may automatically generate a missing training example; this may be done by receiving and/or retrieving a missing input and/or output value and correlating the missing input and/or output value with a corresponding output and/or input value collocated in a data record with the retrieved value, provided by a user and/or other device, or the like.

Continuing to refer to FIG. 11, computer, processor, and/or module may be configured to preprocess training data. “Preprocessing” training data, as used in this disclosure, is transforming training data from raw form to a format that can be used for training a machine learning model. Preprocessing may include sanitizing, feature selection, feature scaling, data augmentation and the like.

Still referring to FIG. 11, computer, processor, and/or module may be configured to sanitize training data. “Sanitizing” training data, as used in this disclosure, is a process whereby training examples are removed that interfere with convergence of a machine-learning model and/or process to a useful result. For instance, and without limitation, a training example may include an input and/or output value that is an outlier from typically encountered values, such that a machine-learning algorithm using the training example will be adapted to an unlikely amount as an input and/or output; a value that is more than a threshold number of standard deviations away from an average, mean, or expected value, for instance, may be eliminated. Alternatively or additionally, one or more training examples may be identified as having poor quality data, where “poor quality” is defined as having a signal to noise ratio below a threshold value. Sanitizing may include steps such as removing duplicative or otherwise redundant data, interpolating missing data, correcting data errors, standardizing data, identifying outliers, and the like. In a nonlimiting example, santization may include utilizing algorithms for identifying duplicate entries or spell-check algorithms.

As a non-limiting example, and with further reference to FIG. 11, images used to train an image classifier or other machine-learning model and/or process that takes images as inputs or generates images as outputs may be rejected if image quality is below a threshold value. For instance, and without limitation, computing device, processor, and/or module may perform blur detection, and eliminate one or more Blur detection may be performed, as a non-limiting example, by taking Fourier transform, or an approximation such as a Fast Fourier Transform (FFT) of the image and analyzing a distribution of low and high frequencies in the resulting frequency-domain depiction of the image; numbers of high-frequency values below a threshold level may indicate blurriness. As a further non-limiting example, detection of blurriness may be performed by convolving an image, a channel of an image, or the like with a Laplacian kernel; this may generate a numerical score reflecting a number of rapid changes in intensity shown in the image, such that a high score indicates clarity and a low score indicates blurriness. Blurriness detection may be performed using a gradient-based operator, which measures operators based on the gradient or first derivative of an image, based on the hypothesis that rapid changes indicate sharp edges in the image, and thus are indicative of a lower degree of blurriness. Blur detection may be performed using Wavelet-based operator, which takes advantage of the capability of coefficients of the discrete wavelet transform to describe the frequency and spatial content of images. Blur detection may be performed using statistics-based operators take advantage of several image statistics as texture descriptors in order to compute a focus level. Blur detection may be performed by using discrete cosine transform (DCT) coefficients in order to compute a focus level of an image from its frequency content.

Continuing to refer to FIG. 11, computing device, processor, and/or module may be configured to precondition one or more training examples. For instance, and without limitation, where a machine learning model and/or process has one or more inputs and/or outputs requiring, transmitting, or receiving a certain number of bits, samples, or other units of data, one or more training examples' elements to be used as or compared to inputs and/or outputs may be modified to have such a number of units of data. For instance, a computing device, processor, and/or module may convert a smaller number of units, such as in a low pixel count image, into a desired number of units, for instance by upsampling and interpolating. As a non-limiting example, a low pixel count image may have 100 pixels, however a desired number of pixels may be 128. Processor may interpolate the low pixel count image to convert the 100 pixels into 128 pixels. It should also be noted that one of ordinary skill in the art, upon reading this disclosure, would know the various methods to interpolate a smaller number of data units such as samples, pixels, bits, or the like to a desired number of such units. In some instances, a set of interpolation rules may be trained by sets of highly detailed inputs and/or outputs and corresponding inputs and/or outputs downsampled to smaller numbers of units, and a neural network or other machine learning model that is trained to predict interpolated pixel values using the training data. As a non-limiting example, a sample input and/or output, such as a sample picture, with sample-expanded data units (e.g., pixels added between the original pixels) may be input to a neural network or machine-learning model and output a pseudo replica sample-picture with dummy values assigned to pixels between the original pixels based on a set of interpolation rules. As a non-limiting example, in the context of an image classifier, a machine-learning model may have a set of interpolation rules trained by sets of highly detailed images and images that have been downsampled to smaller numbers of pixels, and a neural network or other machine learning model that is trained using those examples to predict interpolated pixel values in a facial picture context. As a result, an input with sample-expanded data units (the ones added between the original data units, with dummy values) may be run through a trained neural network and/or model, which may fill in values to replace the dummy values. Alternatively or additionally, processor, computing device, and/or module may utilize sample expander methods, a low-pass filter, or both. As used in this disclosure, a “low-pass filter” is a filter that passes signals with a frequency lower than a selected cutoff frequency and attenuates signals with frequencies higher than the cutoff frequency. The exact frequency response of the filter depends on the filter design. Computing device, processor, and/or module may use averaging, such as luma or chroma averaging in images, to fill in data units in between original data units.

In some embodiments, and with continued reference to FIG. 11, computing device, processor, and/or module may down-sample elements of a training example to a desired lower number of data elements. As a non-limiting example, a high pixel count image may have 256 pixels, however a desired number of pixels may be 128. Processor may down-sample the high pixel count image to convert the 256 pixels into 128 pixels. In some embodiments, processor may be configured to perform downsampling on data. Downsampling, also known as decimation, may include removing every Nth entry in a sequence of samples, all but every Nth entry, or the like, which is a process known as “compression,” and may be performed, for instance by an N-sample compressor implemented using hardware or software. Anti-aliasing and/or anti-imaging filters, and/or low-pass filters, may be used to clean up side-effects of compression.

Further referring to FIG. 11, feature selection includes narrowing and/or filtering training data to exclude features and/or elements, or training data including such elements, that are not relevant to a purpose for which a trained machine-learning model and/or algorithm is being trained, and/or collection of features and/or elements, or training data including such elements, on the basis of relevance or utility for an intended task or purpose for a trained machine-learning model and/or algorithm is being trained. Feature selection may be implemented, without limitation, using any process described in this disclosure, including without limitation using training data classifiers, exclusion of outliers, or the like.

With continued reference to FIG. 11, feature scaling may include, without limitation, normalization of data entries, which may be accomplished by dividing numerical fields by norms thereof, for instance as performed for vector normalization. Feature scaling may include absolute maximum scaling, wherein each quantitative datum is divided by the maximum absolute value of all quantitative data of a set or subset of quantitative data. Feature scaling may include min-max scaling, in which each value X has a minimum value Xₘᵢₙ in a set or subset of values subtracted therefrom, with the result divided by the range of the values, give maximum value in the set or subset Xₘₐₓ:

$${X}_{new} = \frac{X - {X}_{min}}{{X}_{max} - {X}_{min}} .$$

Feature scaling may include mean normalization, which involves use of a mean value of a set and/or subset of values, Xₘₑₐₙ with maximum and minimum values:

$${X}_{new} = \frac{X - {X}_{mean}}{{X}_{max} - {X}_{min}} .$$

Feature scaling may include standardization, where a difference between X and Xₘₑₐₙ is divided by a standard deviation σ of a set or subset of values:

$${X}_{new} = \frac{X - {X}_{mean}}{σ} .$$

Scaling may be performed using a median value of a a set or subset X_{median} and/or interquartile range (IQR), which represents the difference between the 25^{th} percentile value and the 50^{th} percentile value (or closest values thereto by a rounding protocol), such as:

$${X}_{new} = \frac{X - {X}_{median}}{IQR} .$$

Persons skilled in the art, upon reviewing the entirety of this disclosure, will be aware of various alternative or additional approaches that may be used for feature scaling.

Still referring to FIG. 11, machine-learning module 1100 may be configured to perform a lazy-learning process 1120 and/or protocol, which may alternatively be referred to as a “lazy loading” or “call-when-needed” process and/or protocol, may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 1104. Heuristic may include selecting some number of highest-ranking associations and/or training data 1104 elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively or additionally, and with continued reference to FIG. 11, machine-learning processes as described in this disclosure may be used to generate machine-learning models 1124. A “machine-learning model,” as used in this disclosure, is a data structure representing and/or instantiating a mathematical and/or algorithmic representation of a relationship between inputs and outputs, as generated using any machine-learning process including without limitation any process as described above, and stored in memory; an input is submitted to a machine-learning model 1124 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 1124 may be generated by creating an artificial neural network, such as a convolutional neural network comprising an input layer of nodes, one or more intermediate layers, and an output layer of nodes. Connections between nodes may be created via the process of “training” the network, in which elements from a training data 1104 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 11, machine-learning algorithms may include at least a supervised machine-learning process 1128. At least a supervised machine-learning process 1128, as defined herein, include algorithms that receive a training set relating a number of inputs to a number of outputs, and seek to generate one or more data structures representing and/or instantiating one or more mathematical relations relating inputs to outputs, where each of the one or more mathematical relations is optimal according to some criterion specified to the algorithm using some scoring function. For instance, a supervised learning algorithm may include a plurality of historical project data as described above as inputs, a plurality of event progress profiles as outputs, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 1104. Persons skilled in the art, upon reviewing the entirety of this disclosure, will be aware of various possible variations of at least a supervised machine-learning process 1128 that may be used to determine relation between inputs and outputs. Supervised machine-learning processes may include classification algorithms as defined above.

With further reference to FIG. 11, training a supervised machine-learning process may include, without limitation, iteratively updating coefficients, biases, weights based on an error function, expected loss, and/or risk function. For instance, an output generated by a supervised machine-learning model using an input example in a training example may be compared to an output example from the training example; an error function may be generated based on the comparison, which may include any error function suitable for use with any machine-learning algorithm described in this disclosure, including a square of a difference between one or more sets of compared values or the like. Such an error function may be used in turn to update one or more weights, biases, coefficients, or other parameters of a machine-learning model through any suitable process including without limitation gradient descent processes, least-squares processes, and/or other processes described in this disclosure. This may be done iteratively and/or recursively to gradually tune such weights, biases, coefficients, or other parameters. Updating may be performed, in neural networks, using one or more back-propagation algorithms. Iterative and/or recursive updates to weights, biases, coefficients, or other parameters as described above may be performed until currently available training data is exhausted and/or until a convergence test is passed, where a “convergence test” is a test for a condition selected as indicating that a model and/or weights, biases, coefficients, or other parameters thereof has reached a degree of accuracy. A convergence test may, for instance, compare a difference between two or more successive errors or error function values, where differences below a threshold amount may be taken to indicate convergence. Alternatively or additionally, one or more errors and/or error function values evaluated in training iterations may be compared to a threshold.

Still referring to FIG. 11, a computing device, processor, and/or module may be configured to perform method, method step, sequence of method steps and/or algorithm described in reference to this figure, in any order and with any degree of repetition. For instance, a computing device, processor, and/or module may be configured to perform a single step, sequence and/or algorithm repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. A computing device, processor, and/or module may perform any step, sequence of steps, or algorithm in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Further referring to FIG. 11, machine learning processes may include at least an unsupervised machine-learning processes 1132. An unsupervised machine-learning process, as used herein, is a process that derives inferences in datasets without regard to labels; as a result, an unsupervised machine-learning process may be free to discover any structure, relationship, and/or correlation provided in the data. Unsupervised processes 1132 may not require a response variable; unsupervised processes 1132 may be used to find interesting patterns and/or inferences between variables, to determine a degree of correlation between two or more variables, or the like.

Still referring to FIG. 11, machine-learning module 1100 may be designed and configured to create a machine-learning model 1124 using techniques for development of linear regression models. Linear regression models may include ordinary least squares regression, which aims to minimize the square of the difference between predicted outcomes and actual outcomes according to an appropriate norm for measuring such a difference (e.g. a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g. a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 11, machine-learning algorithms may include, without limitation, linear discriminant analysis. Machine-learning algorithm may include quadratic discriminant analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include various forms of latent space regularization such as variational regularization. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized trees, AdaBoost, gradient tree boosting, and/or voting classifier methods. Machine-learning algorithms may include neural net algorithms, including convolutional neural net processes.

Still referring to FIG. 11, a machine-learning model and/or process may be deployed or instantiated by incorporation into a program, apparatus, system and/or module. For instance, and without limitation, a machine-learning model, neural network, and/or some or all parameters thereof may be stored and/or deployed in any memory or circuitry. Parameters such as coefficients, weights, and/or biases may be stored as circuit-based constants, such as arrays of wires and/or binary inputs and/or outputs set at logic “1” and “0” voltage levels in a logic circuit to represent a number according to any suitable encoding system including twos complement or the like or may be stored in any volatile and/or non-volatile memory. Similarly, mathematical operations and input and/or output of data to or from models, neural network layers, or the like may be instantiated in hardware circuitry and/or in the form of instructions in firmware, machine-code such as binary operation code instructions, assembly language, or any higher-order programming language. Any technology for hardware and/or software instantiation of memory, instructions, data structures, and/or algorithms may be used to instantiate a machine-learning process and/or model, including without limitation any combination of production and/or configuration of non-reconfigurable hardware elements, circuits, and/or modules such as without limitation ASICs, production and/or configuration of reconfigurable hardware elements, circuits, and/or modules such as without limitation FPGAs, production and/or of non-reconfigurable and/or configuration non-rewritable memory elements, circuits, and/or modules such as without limitation non-rewritable ROM, production and/or configuration of reconfigurable and/or rewritable memory elements, circuits, and/or modules such as without limitation rewritable ROM or other memory technology described in this disclosure, and/or production and/or configuration of any computing device and/or component thereof as described in this disclosure. Such deployed and/or instantiated machine-learning model and/or algorithm may receive inputs from any other process, module, and/or component described in this disclosure, and produce outputs to any other process, module, and/or component described in this disclosure.

Continuing to refer to FIG. 11, any process of training, retraining, deployment, and/or instantiation of any machine-learning model and/or algorithm may be performed and/or repeated after an initial deployment and/or instantiation to correct, refine, and/or improve the machine-learning model and/or algorithm. Such retraining, deployment, and/or instantiation may be performed as a periodic or regular process, such as retraining, deployment, and/or instantiation at regular elapsed time periods, after some measure of volume such as a number of bytes or other measures of data processed, a number of uses or performances of processes described in this disclosure, or the like, and/or according to a software, firmware, or other update schedule. Alternatively or additionally, retraining, deployment, and/or instantiation may be event-based, and may be triggered, without limitation, by user inputs indicating sub-optimal or otherwise problematic performance and/or by automated field testing and/or auditing processes, which may compare outputs of machine-learning models and/or algorithms, and/or errors and/or error functions thereof, to any thresholds, convergence tests, or the like, and/or may compare outputs of processes described herein to similar thresholds, convergence tests or the like. Event-based retraining, deployment, and/or instantiation may alternatively or additionally be triggered by receipt and/or generation of one or more new training examples; a number of new training examples may be compared to a preconfigured threshold, where exceeding the preconfigured threshold may trigger retraining, deployment, and/or instantiation.

Still referring to FIG. 11, retraining and/or additional training may be performed using any process for training described above, using any currently or previously deployed version of a machine-learning model and/or algorithm as a starting point. Training data for retraining may be collected, preconditioned, sorted, classified, sanitized or otherwise processed according to any process described in this disclosure. Training data may include, without limitation, training examples including inputs and correlated outputs used, received, and/or generated from any version of any system, module, machine-learning model or algorithm, apparatus, and/or method described in this disclosure; such examples may be modified and/or labeled according to user feedback or other processes to indicate desired results, and/or may have actual or measured results from a process being modeled and/or predicted by system, module, machine-learning model or algorithm, apparatus, and/or method as “desired” results to be compared to outputs for training processes as described above.

Redeployment may be performed using any reconfiguring and/or rewriting of reconfigurable and/or rewritable circuit and/or memory elements; alternatively, redeployment may be performed by production of new hardware and/or software components, circuits, instructions, or the like, which may be added to and/or may replace existing hardware and/or software components, circuits, instructions, or the like.

Further referring to FIG. 11, one or more processes or algorithms described above may be performed by at least a dedicated hardware unit 1136. A “dedicated hardware unit,” for the purposes of this figure, is a hardware component, circuit, or the like, aside from a principal control circuit and/or processor performing method steps as described in this disclosure, that is specifically designated or selected to perform one or more specific tasks and/or processes described in reference to this figure, such as without limitation preconditioning and/or sanitization of training data and/or training a machine-learning algorithm and/or model. A dedicated hardware unit 1136 may include, without limitation, a hardware unit that can perform iterative or massed calculations, such as matrix-based calculations to update or tune parameters, weights, coefficients, and/or biases of machine-learning models and/or neural networks, efficiently using pipelining, parallel processing, or the like; such a hardware unit may be optimized for such processes by, for instance, including dedicated circuitry for matrix and/or signal processing operations that includes, e.g., multiple arithmetic and/or logical circuit units such as multipliers and/or adders that can act simultaneously and/or in parallel or the like. Such dedicated hardware units 1136 may include, without limitation, graphical processing units (GPUs), dedicated signal processing modules, FPGA or other reconfigurable hardware that has been configured to instantiate parallel processing units for one or more specific tasks, or the like, A computing device, processor, apparatus, or module may be configured to instruct one or more dedicated hardware units 1136 to perform one or more operations described herein, such as evaluation of model and/or algorithm outputs, one-time or iterative updates to parameters, coefficients, weights, and/or biases, and/or any other operations such as vector and/or matrix operations as described in this disclosure.

In the context of hardware entities of FIG. 5 of the present patent application, the term “connection,” the term “component” and/or similar terms are intended to be physical, but are not necessarily always tangible. Whether or not these terms refer to tangible subject matter, thus, may vary in a particular context of usage. As an example, a tangible connection and/or tangible connection path may be made, such as by a tangible, electrical connection, such as an electrically conductive path comprising metal or other conductor, that is able to conduct electrical current between two tangible components. Likewise, a tangible connection path may be at least partially affected and/or controlled, such that, as is typical, a tangible connection path may be open or closed, at times resulting from influence of one or more externally derived signals, such as external currents and/or voltages, such as for an electrical switch. Non-limiting illustrations of an electrical switch include a transistor, a diode, etc. However, a “connection” and/or “component,” in a particular context of usage, likewise, although physical, can also be non-tangible, such as a connection between a client and a server over a network, particularly a wireless network, which generally refers to the ability for the client and server to transmit, receive, and/or exchange communications, as discussed in more detail later.

In a particular context of usage, such as a particular context in which tangible components are being discussed, therefore, the terms “coupled” and “connected” are used in a manner so that the terms are not synonymous. Similar terms may also be used in a manner in which a similar intention is exhibited. Thus, “connected” is used to indicate that two or more tangible components and/or the like, for example, are tangibly in direct physical contact. Thus, using the previous example, two tangible components that are electrically connected are physically connected via a tangible electrical connection, as previously discussed. However, “coupled,” is used to mean that potentially two or more tangible components are tangibly in direct physical contact. Nonetheless, “coupled” is also used to mean that two or more tangible components and/or the like are not necessarily tangibly in direct physical contact, but are able to co-operate, liaise, and/or interact, such as, for example, by being “optically coupled.” Likewise, the term “coupled” is also understood to mean indirectly connected. It is further noted, in the context of the present patent application, since memory, such as a memory component and/or memory states, is intended to be non-transitory, the term physical, at least if used in relation to memory necessarily implies that such memory components and/or memory states, continuing with the example, are tangible.

Unless otherwise indicated, in the context of the present patent application, the term “or” if used to associate a list, such as A, B, or C, is intended to mean A, B, and C, here used in the inclusive sense, as well as A, B, or C, here used in the exclusive sense. With this understanding, “and” is used in the inclusive sense and intended to mean A, B, and C; whereas “and/or” can be used in an abundance of caution to make clear that all of the foregoing meanings are intended, although such usage is not required. In addition, the term “one or more” and/or similar terms is used to describe any feature, structure, characteristic, and/or the like in the singular, “and/or” is also used to describe a plurality and/or some other combination of features, structures, characteristics, and/or the like. Likewise, the term “based on” and/or similar terms are understood as not necessarily intending to convey an exhaustive list of factors, but to allow for existence of additional factors not necessarily expressly described.

In some situations, however, as indicated, potential influences may be complex. Therefore, seeking to understand appropriate factors to consider may be particularly challenging. In such situations, it is, therefore, not unusual to employ heuristics with respect to generating one or more estimates. Heuristics refers to use of experience related approaches that may reflect realized processes and/or realized results, such as with respect to use of actual values of predecessor events, for example. Heuristics, for example, may be employed in situations where more analytical approaches may be overly complex and/or nearly intractable. Thus, regarding claimed subject matter, an innovative feature may include, in an example embodiment, heuristics that may be employed, for example, to estimate and/or predict one or more actual values of predecessor events.

The terms “correspond,” “reference,” “associate,” and/or similar terms relate to signals, signal samples and/or states, e.g., components of a signal measurement vector, which may be stored in memory and/or employed with operations to generate results, depending, at least in part, on the above-mentioned, signal samples and/or signal sample states. For example, a signal sample measurement vector may be stored in a memory location and further referenced wherein such a reference may be embodied and/or described as a stored relationship. A stored relationship may be employed by associating (e.g., relating) one or more memory addresses to one or more another memory addresses, for example, and may facilitate an operation, involving, at least in part, a combination of signal samples and/or states stored in memory (e.g., memory 554 of FIG. 5), such as for processing by a processor and/or similar device, for example. Thus, in a particular context, “associating,” “referencing,” and/or “corresponding” may, for example, refer to an executable process of accessing contents of memory 554 of two or more memory locations, for example, to facilitate execution of one or more operations among signal samples and/or states, wherein one or more results of the one or more operations may likewise be employed for additional processing, such as in other operations, or may be stored in the same or other memory locations, as may, for example, be directed by executable instructions. Furthermore, terms “fetching” and “reading” or “storing” and “writing” are to be understood as interchangeable terms for the respective operations, e.g., a result may be fetched (or read) from a memory location; likewise, a result may be stored in (or written to) a memory location.

With advances in technology, it has become more typical to employ distributed computing and/or communication approaches in which portions of a process, such as signal processing of signal samples, for example, may be allocated among various devices, including one or more client devices and/or one or more server devices, via a computing and/or communications network, for example. A network, such as devices of network 530 of FIG. 5, may comprise two or more devices, such as network devices and/or computing devices, and/or may couple devices, such as network devices and/or computing devices, so that signal communications, such as in the form of signal packets and/or signal frames (e.g., comprising one or more signal samples), for example, may be exchanged, such as between a server device and/or a client device, as well as other types of devices, including between wired and/or wireless devices coupled via a wired and/or wireless network, for example.

In the context of the present patent application, the term network device, such as with respect to devices of network 530 of FIG. 5, refers to any device capable of communicating via and/or as part of a network and may comprise a computing device. While network devices may be capable of communicating signals (e.g., signal packets and/or frames), such as via a wired and/or wireless network, they may also be capable of performing operations associated with a computing device, such as arithmetic and/or logic operations, processing and/or storing operations (e.g., storing signal samples), such as in memory as tangible, physical memory states, and/or may, for example, operate as a server device and/or a client device in various embodiments. Network devices capable of operating as a server device, a client device and/or otherwise, may include, as examples, dedicated rack-mounted servers, desktop computers, laptop computers, set top boxes, tablets, netbooks, smart phones, wearable devices, integrated devices combining two or more features of the foregoing devices, and/or the like, or any combination thereof. As mentioned, signal packets and/or frames, for example, may be exchanged, such as between a server device and/or a client device, as well as other types of devices, including between wired and/or wireless devices coupled via a wired and/or wireless network, for example, or any combination thereof. It is noted that the terms, server, server device, server computing device, server computing platform and/or similar terms are used interchangeably. Similarly, the terms “client,” “client device,” “client computing device,” “client computing platform,” and/or similar terms are also used interchangeably. While in some instances, for ease of description, these terms may be used in the singular, such as by referring to a “client device” or a “server device,” the description is intended to encompass one or more client devices and/or one or more server devices, as appropriate. Along similar lines, references to a “database” are understood to mean, one or more databases and/or portions thereof, as appropriate.

It should be understood that for ease of description, a device of network 530 may be embodied and/or described in terms of a computing device and vice-versa. However, it should further be understood that this description should in no way be construed so that claimed subject matter is limited to one embodiment, such as only a computing device and/or only a network device, but, instead, may be embodied as a variety of devices or combinations thereof, including, for example, one or more illustrative examples.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

The terms “computer-implemented spreadsheet” and “computer-implemented calendar” or variations of these terms are utilized in this document to refer to a set of stored memory states and/or a set of physical signals associated in a manner so as to thereby at least logically form a file (e.g., electronic) and/or an electronic document. That is, it is not meant to implicitly reference a particular syntax, format and/or approach used, for example, with respect to a set of associated memory states and/or a set of associated physical signals. If a particular type of file storage format and/or syntax, for example, is intended, it is referenced expressly. It is further noted an association of memory states, for example, may be in a logical sense and not necessarily in a tangible, physical sense. Thus, although signal and/or state components of a file and/or an electronic document, for example, are to be associated logically, storage thereof, for example, may reside in one or more different places in a tangible, physical memory, in an embodiment.

Also, in the context of the present patent application, the term parameters (e.g., one or more parameters) refer to material descriptive of a collection of signal samples, such as one or more electronic documents and/or electronic files, and exist in the form of physical signals and/or physical states, such as memory states. For example, one or more parameters, such as referring to an electronic document and/or an electronic file comprising an image, may include, as examples, time of day at which an image was captured, latitude and longitude of an image capture device, such as a camera, for example, etc. In another example, one or more parameters relevant to digital content, such as digital content comprising a technical article, as an example, may include one or more authors, for example. Claimed subject matter is intended to embrace meaningful, descriptive parameters in any format, so long as the one or more parameters comprise physical signals and/or states, which may include, as parameter examples, collection name (e.g., electronic file and/or electronic document identifier name), technique of creation, purpose of creation, time and date of creation, logical path if stored, coding formats (e.g., type of computer instructions, such as a markup language) and/or standards and/or specifications used so as to be protocol compliant (e.g., meaning substantially compliant and/or substantially compatible) for one or more uses, and so forth.

As suggested previously, communications between a computing device and/or a network device (e.g., a device of network 530) and a wireless network may be in accordance with known and/or to be developed network protocols including, for example, global system for mobile communications (GSM), enhanced data rate for GSM evolution (EDGE), 802.11b/g/n/h, etc., and/or worldwide interoperability for microwave access (WiMAX). A computing device and/or a networking device may also have a subscriber identity module (SIM) card, which, for example, may comprise a detachable or embedded smart card that is able to store subscription content of a user, and/or is also able to store a contact list. It is noted, however, that a SIM card may also be electronic, meaning that is may simply be stored in a particular location in memory of the computing and/or networking device. A user may own the computing device and/or network device or may otherwise be a user, such as a primary user, for example. A device may be assigned an address by a wireless network operator, a wired network operator, and/or an Internet Service Provider (ISP). For example, an address may comprise a domestic or international telephone number, an Internet Protocol (IP) address, and/or one or more other identifiers. In other embodiments, a computing and/or communications network may be embodied as a wired network, wireless network, or any combinations thereof.

A computing platform and/or device of network 530 may include and/or may execute a variety of now known and/or to be developed operating systems, derivatives and/or versions thereof, including computer operating systems, such as Windows, iOS, Linux, a mobile operating system, such as iOS, Android, Windows Mobile, and/or the like. A computing platform and/or device of network 530 may include and/or may execute a variety of possible applications, such as a client software application enabling communication with other devices. For example, one or more messages (e.g., content) may be communicated, such as via one or more protocols, now known and/or later to be developed, suitable for communication of email, short message service (SMS), and/or multimedia message service (MMS), including via a network, such as a social network, formed at least in part by a portion of a computing platform and/or communications network, including, but not limited to, Facebook, LinkedIn, Twitter, and/or Flickr, to provide only a few examples. A computing and/or network device may also include executable computer instructions to process and/or communicate digital content, such as, for example, textual content, digital multimedia content, and/or the like. A computing platform and/or network device may also include executable computer instructions to perform a variety of possible tasks, such as browsing, searching, playing various forms of digital content, including locally stored and/or streamed video, and/or games. The foregoing is provided merely to illustrate that claimed subject matter is intended to include a wide range of possible features and/or capabilities.

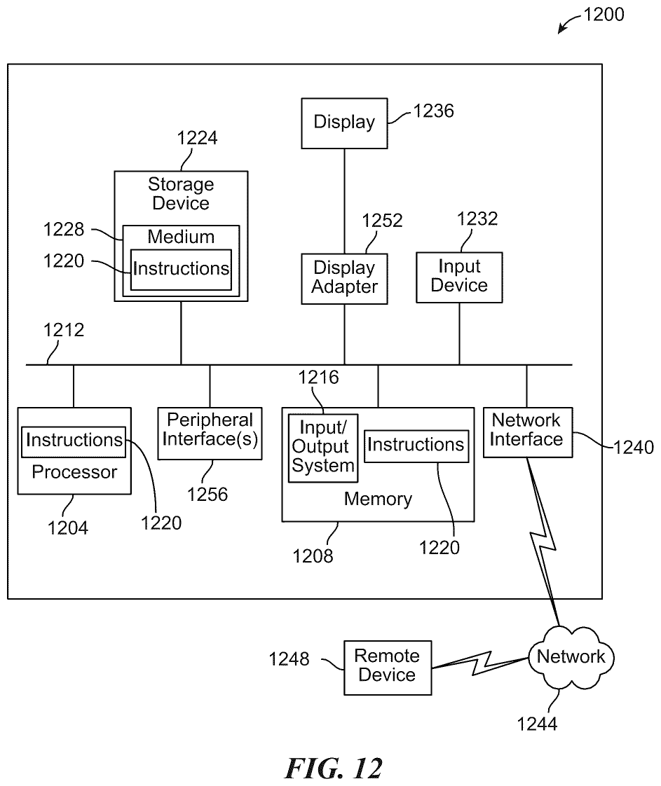

FIG. 12 shows a diagrammatic representation of one embodiment of a computing device in the exemplary form of a computer system 1200 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 1200 includes a processor 1204 and a memory 1208 that communicate with each other, and with other components, via a bus 1212. Bus 1212 may include any of several types of bus structures including, but not limited to, a memory bus, a memory controller, a peripheral bus, a local bus, and any combinations thereof, using any of a variety of bus architectures.

Processor 1204 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 1204 may be organized according to Von Neumann and/or Harvard architecture as a non-limiting example. Processor 1204 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), system on module (SOM), and/or system on a chip (SoC).

Memory 1208 may include various components (e.g., machine-readable media) including, but not limited to, a random-access memory component, a read only component, and any combinations thereof. In one example, a basic input/output system 1216 (BIOS), including basic routines that help to transfer information between elements within computer system 1200, such as during start-up, may be stored in memory 1208. Memory 1208 may also include (e.g., stored on one or more machine-readable media) instructions (e.g., software) 1220 embodying any one or more of the aspects and/or methodologies of the present disclosure. In another example, memory 1208 may further include any number of program modules including, but not limited to, an operating system, one or more application programs, other program modules, program data, and any combinations thereof.

Computer system 1200 may also include a storage device 1224. Examples of a storage device (e.g., storage device 1224) include, but are not limited to, a hard disk drive, a magnetic disk drive, an optical disc drive in combination with an optical medium, a solid-state memory device, and any combinations thereof. Storage device 1224 may be connected to bus 1212 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 1224 (or one or more components thereof) may be removably interfaced with computer system 1200 (e.g., via an external port connector (not shown)). Particularly, storage device 1224 and an associated machine-readable medium 1228 may provide nonvolatile and/or volatile storage of machine-readable instructions, data structures, program modules, and/or other data for computer system 1200. In one example, software 1220 may reside, completely or partially, within machine-readable medium 1228. In another example, software 1220 may reside, completely or partially, within processor 1204.

Computer system 1200 may also include an input device 1232. In one example, a user of computer system 1200 may enter commands and/or other information into computer system 1200 via input device 1232. Examples of an input device 1232 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 1232 may be interfaced to bus 1212 via any of a variety of interfaces (not shown) including, but not limited to, a serial interface, a parallel interface, a game port, a USB interface, a FIREWIRE interface, a direct interface to bus 1212, and any combinations thereof. Input device 1232 may include a touch screen interface that may be a part of or separate from display 1236, discussed further below. Input device 1232 may be utilized as a user selection device for selecting one or more graphical representations in a graphical interface as described above.

A user may also input commands and/or other information to computer system 1200 via storage device 1224 (e.g., a removable disk drive, a flash drive, etc.) and/or network interface device 1240. A network interface device, such as network interface device 1240, may be utilized for connecting computer system 1200 to one or more of a variety of networks, such as network 1244, and one or more remote devices 1248 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 1244, may employ a wired and/or a wireless mode of communication. In general, any network topology may be used. Information (e.g., data, software 1220, etc.) may be communicated to and/or from computer system 1200 via network interface device 1240.

Computer system 1200 may further include a video display adapter 1252 for communicating a displayable image to a display device, such as display device 1236. Examples of a display device include, but are not limited to, a liquid crystal display (LCD), a cathode ray tube (CRT), a plasma display, a light emitting diode (LED) display, and any combinations thereof. Display adapter 1252 and display device 1236 may be utilized in combination with processor 1204 to provide graphical representations of aspects of the present disclosure. In addition to a display device, computer system 1200 may include one or more other peripheral output devices including, but not limited to, an audio speaker, a printer, and any combinations thereof. Such peripheral output devices may be connected to bus 1212 via a peripheral interface 1256. Examples of a peripheral interface include, but are not limited to, a serial port, a USB connection, a FIREWIRE connection, a parallel connection, and any combinations thereof.

Algorithmic descriptions and/or symbolic representations are examples of techniques used by those of ordinary skill in the signal processing and/or related arts to convey the substance of their work to others skilled in the art. An algorithm is, in the context of the present patent application, and generally, is considered to be a self-consistent sequence of operations and/or similar signal processing leading to a desired result. In the context of the present patent application, operations and/or processing involve physical manipulation of physical quantities. Typically, although not necessarily, such quantities may take the form of electrical and/or magnetic signals and/or states capable of being stored, transferred, combined, compared, processed and/or otherwise manipulated, for example, as electronic signals and/or states making up components of various forms of digital content, such as signal measurements, text, images, video, audio, etc.

It has proven convenient at times, principally for reasons of common usage, to refer to such physical signals and/or physical states as bits, values, elements, parameters, symbols, characters, terms, numbers, numerals, measurements, content and/or the like. It should be understood, however, that all of these and/or similar terms are to be associated with appropriate physical quantities and are merely convenient labels. Unless specifically stated otherwise, as apparent from the preceding discussion, it is appreciated that throughout this specification discussions utilizing terms such as “processing,” “computing,” “calculating,” “determining,” “establishing,” “obtaining,” “identifying,” “selecting,” “generating,” and/or the like may refer to actions and/or processes of a specific apparatus, such as a special purpose computing platform and/or a similar special purpose computing platform and/or network device (e.g., a device of network 530). In the context of this specification, therefore, a special purpose computing platform and/or a similar special purpose computing and/or network device is capable of processing, manipulating and/or transforming signals and/or states, typically in the form of physical electronic and/or magnetic quantities, within memories, registers, and/or other storage devices, processing devices, and/or display devices of the special purpose computing platform and/or similar special purpose computing and/or network device. In the context of this particular patent application, as mentioned, the term “specific apparatus” therefore includes a general purpose computing platform and/or network device, such as a general purpose computer, once it is programmed to perform particular functions, such as pursuant to program software instructions.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and/or storage of charge or a release of stored charge. Likewise, in other memory devices, a change of state may comprise a physical change, such as a transformation in magnetic orientation. Likewise, a physical change may comprise a transformation in molecular structure, such as from crystalline form to amorphous form or vice-versa. In still other memory devices, a change in physical state may involve quantum mechanical phenomena, such as, superposition, entanglement, and/or the like, which may involve quantum bits (qubits), for example. The foregoing is not intended to be an exhaustive list of all examples in which a change in state from a binary one to a binary zero or vice-versa in a memory device may comprise a transformation, such as a physical, but non-transitory, transformation. Rather, the foregoing is intended as illustrative examples.

In the preceding description, various aspects of claimed subject matter have been described. For purposes of explanation, specifics, such as amounts, systems and/or configurations, as examples, were set forth. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all modifications and/or changes as fall within claimed subject matter.

What is claimed is:

1. A method for modeling a multi-event process, wherein the method comprises:
loading, by at least one processor, a digitized representation of a plurality of events into a memory communicatively connected to the at least one processor, wherein the plurality of events comprises:
a first sub-set of events linked to a sub-set of historical events;
generating, by the at least one processor, a first visual representation data structure configured to cause a remote device communicatively connected to the at least one processor to display a first visual representation of the digitized representation of the plurality of events, wherein generating the first visual representation data structure comprises:
generating a plurality of visual indicators, wherein each visual indicator of the plurality of visual indicators is configured to represent at least a percentage of an event progress of the first sub-set of events;
modifying, by the at least one processor, at least one event attribute associated with the plurality of events;
computing, by the at least one processor, an event progress profile corresponding to the first sub-set of events as a function of the modified at least one event attribute; and
generating, by the at least one processor, a second visual representation data structure configured to cause the remote device to display a second visual representation of the digitized representation of the plurality of events.

2. The method of claim 1, wherein at least one event of the first sub-set of events is linked at least one historical events of the sub-set of historical events such that the at least one event of the first sub-set of events does not initiate until a completion of at least a percentage of the at least one historical event of the sub-set of historical events.

3. The method of claim 1, wherein modifying the at least one event attribute comprises:
modifying the at least one event attribute associated with the first sub-set of events as a function of an event progress profile corresponding to the sub-set of historical events.

4. The method of claim 1, wherein modifying the at least one event attribute comprises:
modifying the at least one event attribute associated with the first sub-set of events as a function of a performance factor associated with the sub-set of historical events.

5. The method of claim 1, wherein modifying the at least one event attribute comprises:
modifying the at least one event attribute associated with the first sub-set of events using an event attribute modifier.

6. The method of claim 5, wherein the event attribute modifier comprises:
a linear element having a first interactive end corresponding to a start time of at least one event of the first sub-set of events and a second interactive end corresponding to an end time of the at least one event of the first sub-set of events.

7. The method of claim 6, further comprises:
selecting, by the at least one processor, at least one time period from a plurality of selectable time periods to represent a progress of the first sub-set of events at a user interface of the display device by locating the first interactive end and the second interactive end of the linear element.

8. The method of claim 1, further comprises:
receiving, by the at least one processor, a user input, wherein the user input comprises at least a modification of at least one event attribute associated with at least one event of the first sub-set of events;
automatically adjusting, by the at least one processor, the first sub-set of events of the plurality of events as a function of the user input; and
recomputing, by the at least one processor, the event progress profile corresponding to the first sub-set of events based on the adjustment of the first sub-set of events.

9. The method of claim 8, wherein recomputing the event progress profile comprises respreading the adjusted first sub-set of events over a future duration.

10. The method of claim 1, wherein the plurality of visual indicators of the first and the second visual representations correspond to indicators of a bar graph.

11. An apparatus for modeling a multi-event process, wherein the apparatus comprises:
at least one processor; and
a memory communicatively connected to the at least one processor, wherein the memory contains instructions configuring the at least one processor:
load a digitized representation of a plurality of events into the memory, wherein the plurality of events comprises:
a first sub-set of events linked to a sub-set of historical events;
generate a first visual representation data structure configured to cause a remote device communicatively connect to the at least one processor to display a first visual representation of the digitized representation of the plurality of events, wherein generating the first visual representation data structure comprises:
generating a plurality of visual indicators, wherein each visual indicator of the plurality of visual indicators is configured to represent at least a percentage of an event progress of the first sub-set of events;
modify at least one event attribute associated with the plurality of events;
compute an event progress profile corresponding to the first sub-set of events as a function of the modified at least one event attribute; and
generate a second visual representation data structure configured to cause the remote device to display a second visual representation of the digitized representation of the plurality of events using the display device.

12. The apparatus of claim 11, wherein at least one event of the first sub-set of events is linked at least one historical events of the sub-set of historical events such that the at least one event of the first sub-set of events does not initiate until a completion of at least a percentage of the at least one historical event of the sub-set of historical events.

13. The apparatus of claim 11, wherein modifying the at least one event attribute comprises:
modifying the at least one event attribute associated with the first sub-set of events as a function of an event progress profile corresponding to the sub-set of historical events.

14. The apparatus of claim 11, wherein modifying the at least one event attribute comprises:
modifying the at least one event attribute associated with the first sub-set of events as a function of a performance factor associated with the sub-set of historical events.

15. The apparatus of claim 11, wherein modifying the at least one event attribute comprises:
modifying the at least one event attribute associated with the first sub-set of events using an event attribute modifier.

16. The apparatus of claim 15, wherein the event attribute modifier comprises:
a linear element having a first interactive end corresponding to a start time of a first event of the first sub-set of events and a second interactive end corresponding to an end time of a second event of the first sub-set of events.

17. The apparatus of claim 16, wherein the memory further contains instructions configuring the at least a processor to:
select at least one time period from a plurality of selectable time periods to represent a progress of the first sub-set of events at a user interface of the display device by locating the first interactive end and the second interactive end of the linear element.

18. The apparatus of claim 11, wherein the memory further contains instructions configuring the at least a processor to:
receive a user input, wherein the user input comprises at least a modification of at least one event attribute associated with at least one event of the first sub-set of events;
automatically adjust the first sub-set of events of the plurality of events as a function of the user input; and
recompute the event progress profile corresponding to the first sub-set of events based on the adjustment of the first sub-set of events.

19. The apparatus of claim 18, wherein recomputing the event progress profile comprises respreading the adjusted first sub-set of events over a future duration.

20. The apparatus of claim 11, wherein the plurality of visual indicators of the first and the second visual representations correspond to indicators of a bar graph.
